(19) United States
(12) Patent Application Publication
(10) Pub. No.: US 2026/0220757 A1
(43) Pub. Date: Jul. 30, 2026

(54) DYNAMIC IMAGE RECOGNITION AND INTELLIGENT REACTION FOR DATACENTERS

(71) Applicant: Nvidia Corporation, Santa Clara, CA (US)

(72) Inventors: Ryan Albright, Beaverton, OR (US); William Andrew Mecham, Elk Grove, CA (US); Siddha Ganju, San Jose, CA (US); Elad Mentovich, Tel Aviv (IL); Aaron Carkin, Hillsboro, OR (US); Benjamin Goska, Portland, OR (US); Jordan Levy, Portland, OR (US); William Ryan Weese, Portland, OR (US); Scott Millward, San Jose, CA (US)

(21) Appl. No.: 19/040,362

(22) Filed: Jan. 29, 2025

(51) Int. Cl. G06T 7/00; G06F 11/07; G06V 20/52

(52) U.S. Cl. CPC G06T 7/0004; G06F 11/0709; G06F 11/0793; G06V 20/52

(57) ABSTRACT

Approaches presented herein provide for the automated detection of physical state information for a set of components, such as those present in a datacenter. The physical state information can be obtained by using one or more sensors (e.g., cameras) to capture visual or other physical data for one or more components. The captured sensor data can be analyzed to determine physical state aspects for various components. This observed state can be compared, using an artificial intelligence (AI) model trained on physical language, to a typical set of state data to attempt to identify any anomalies. If any anomalies are identified, an AI actor can determine whether any of those anomalies are related to a current or potential problem, and if so, can generate some type of notification or alarm to cause the problem to be investigated. In at least one embodiment, a robotic assembly can be used that can move between various components and use one or more sensors to capture at least a portion of the appropriate physical state data.

### TECHNICAL FIELD

This disclosure relates to the operation of computing resources, and in particular relates to the monitoring and maintenance of computing resources in a complex computing environment such as a datacenter or server farm.

### BACKGROUND

As an increasing amount of complex operations are being performed on increasingly large and varied datasets, computing environments such as datacenters and server farms are also becoming increasingly complex. Further, the individual resources-such as servers and processing units—in those environments are getting increasingly complex as well. For example, each server tray in a given rack or server product can require its own set of cables, fiber, management, storage, networking, and power, among other such components and processes. Individual components can each have specific ways in which they are supposed to be physically installed, and may have specific states or conditions when operating as intended. In many environments, issues with various computing resources are typically identified when a resource goes down or an alarm is generated, or when generated metrics indicate that there is a performance issue. A human technician then typically is dispatched to go to at least one physical location that appears to be associated with the issue, and analyze the state of various components to attempt to determine a potential cause of the issue. In complex systems, this may include attempting to diagnose a problem based on dozens if not hundreds of potential components, such as whether cables are installed properly in the correct location, lights are in the correct state, fans are operating, and so forth. Such an approach can be relatively slow and subject to human error, and in many cases, it may be difficult or at least time consuming for a human to determine how each of dozens of cables in a particular server rack should be connected, which states dozens of lights should be in, etc., to be able to determine whether there is an issue with any of these components.

### BRIEF DESCRIPTION OF THE DRAWINGS

Various embodiments in accordance with the present disclosure will be described with reference to the drawings, in which:

FIG. 1A illustrates an example datacenter system architecture in which aspects of various embodiments can be implemented, according to at least one embodiment.

FIG. 1B illustrates an example layout of components in a datacenter, according to at least one embodiment.

FIG. 2A illustrates use of at least one imaging assembly to obtain information about various datacenter components, according to at least one embodiment.

FIG. 2B illustrates example components in a server rack that can have image data captured and analyzed to help determine state information, according to at least one embodiment;

FIGS. 3A, 3B, and 3C illustrate example camera assemblies that can be used to capture information about one or more datacenter components, according to at least one embodiment.

FIG. 4 illustrates an example process that can be performed to capture and analyze image data for one or more components to attempt to diagnose the cause of an issue in a datacenter, according to at least one embodiment.

FIG. 5 illustrates an example datacenter system, according to at least one embodiment;

FIG. 6 is a block diagram illustrating a computer system, according to at least one embodiment;

FIG. 7 is a block diagram illustrating a computer system, according to at least one embodiment;

FIG. 8 illustrates components of an example computing system, according to one or more embodiments.

FIG. 9 illustrates an example enterprise AI system that can be used to perform aspects of one or more embodiments.

FIG. 10 is an example data flow diagram for an advanced computing pipeline, in accordance with at least one embodiment.

FIG. 11 is a system diagram for an example system for training, adapting, instantiating and deploying machine learning models in an advanced computing pipeline, in accordance with at least one embodiment.

FIGS. 12A and 12B illustrate a data flow diagram for a process to train a machine learning model, as well as client-server architecture to enhance annotation tools with pre-trained annotation models, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches in accordance with various illustrative embodiments can provide for the automated analysis of computing environments, such as datacenters, that include a number of active, connected components. These components, such as servers and switches, can have a number of connections, lights, latches, and other components or mechanisms that need to be attached, connected, installed, and/or functioning in a specific way for the components to be interoperating properly. Approaches in accordance with various embodiments can incorporate the use of visual information, along with telemetry and other textual state data for various components, to provide a more informed analysis of the state of these components. At least one camera (or other imaging sensor or device) can be used to capture visual information (or other physical state data, such as sound, heat, or odor data), about one or more components. This may include, for example, capturing image or video data of the back of a server, which may include data about cables connected to the server, whether one or more cables are frayed or incorrectly attached, colors or patterns of lights illuminated on the server, whether the server is seated properly, and other such information. The camera may be attached to the server, a server rack, or another such location, or may be on a mobile device (such as a robot or tablet computer) that can be moved into position to capture such information. Other types of information can be captured as well using other sensors or mechanisms, as may relate to sound, odor, motion, and the like. The information (including the captured image data and other state or telemetry data available for the components being analyzed) can be fed to a machine learning (ML) model, such as a large language model (LLM) or vision language model (VLM). The ML model can use the information in aggregate to generate responses to queries about the state of one or more components, and can also automatically generate queries for further data gathering.

As an example, if it is determined that a component is not getting power then the visual data may provide further contextual information as to the physical state of that component, whether a relevant power cable is properly attached, and whether a light on the power supply shows that the power supply is on and in a proper state, etc. If the captured image and/or sensor information does not show this information, then an AI actor can request or cause such image information to be captured, such as by sending a request or instruction to a robot or human holding an image capture device. Upon making a determination as to the state of the system, and the cause of any potential issues, a report can automatically be generated that includes at least some of this information, as well as one or more recommendations, visual evidence, or other such information. If possible, a robot may be instructed to make one or more physical adjustments determined to be appropriate for remediation or maintenance, such as to plug in a loose cable or replace a network card that is not operational. Such an approach provides for contextual interpretation by an intelligent actor, as well as remediation of identified issues, based on context that includes visual information and/or other such captured data. Such an approach also allows an automated actor to be able to obtain information that would normally be obtained by a human technician physically present near a given component, such as to determine through visual analysis whether all the cables are plugged in properly, whether the LEDs are blinking or colored in a certain way that provides information, and so forth, that is part of the contextual language about such a component.

Variations of this and other such functionality can be used as well within the scope of the various embodiments as would be apparent to one of ordinary skill in the art in light of the teachings and suggestions contained herein.

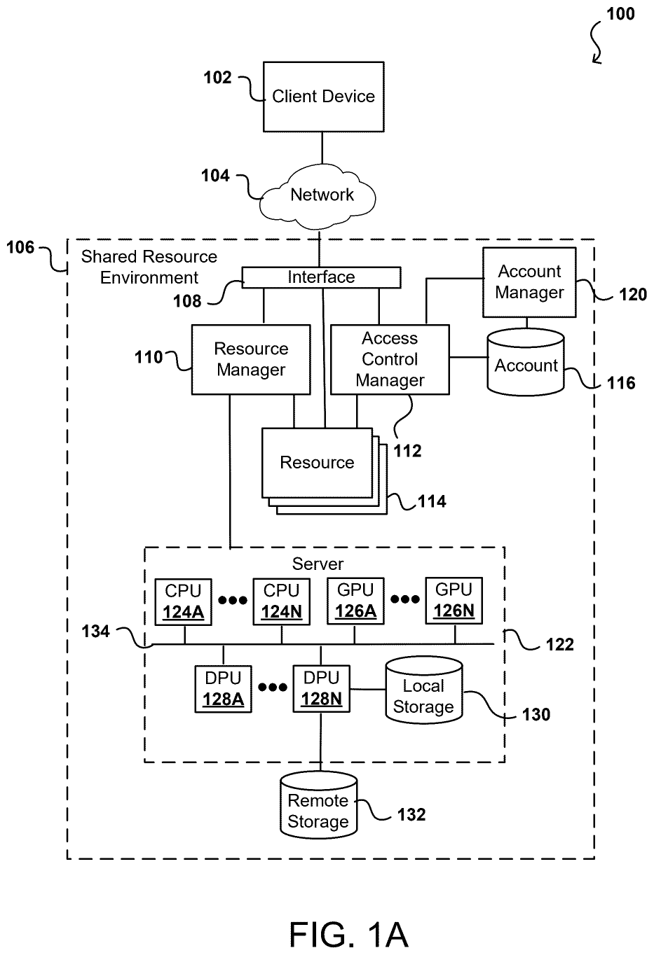

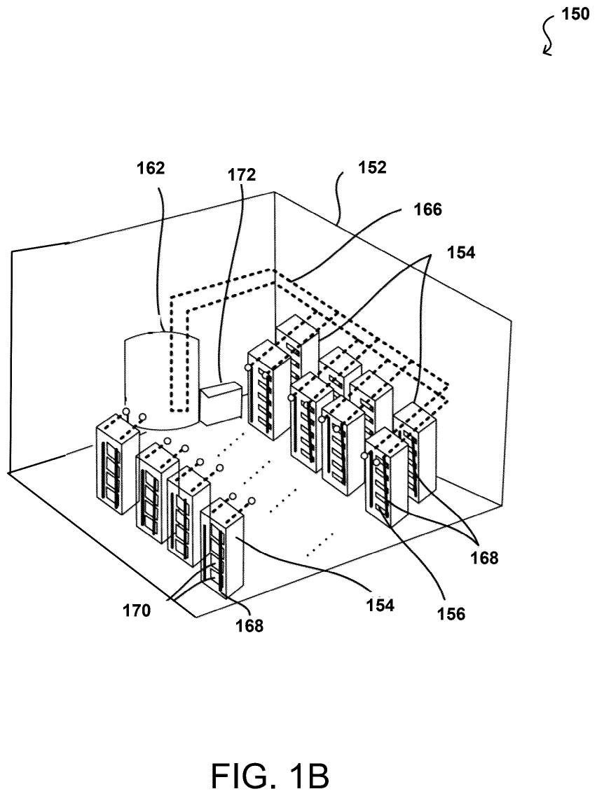

Environments such as datacenters can be used to perform various computing operations on behalf of a number of different entities, such as by using a pool of available resource capacity. FIG. 1A illustrates an example of one such architecture 100 that can be used in accordance with at least one embodiment. In this example, a user is able to use a client device 102 to submit one or more requests to access one or more resources, or to perform a task using one or more resources, among other such options. Such a request can be submitted over at least one network 104, such as the Internet or a cellular network, and received to an interface, address, or endpoint in a shared resource environment 106. The request can be received to an interface, such as an application programming interface (API) of an interface layer 108, for example, which may include other networking devices as well, as may include routers, network switches (e.g., an NV-Switch or Spectrum-X switch), load balancers, and the like. In this example, a request from a client device 102 may first need to be analyzed to determine whether the client device, user, or other entity associated with the request has access to one or more resources to be used to process the request, as well as to determine whether the type of access permitted allows for performance of the requested operation.

In this example, information for the request can be directed to an access control manager 112, or other such component, system, or service. The access control manager 112 can perform various tasks to determine and/or manage access to a set of shared resources 114, such as to extract relevant information from a received request and compare, by an account manager 120 or other such system or service, information for the request against information in an account repository 116 or other such location. If it is determined that the request is associated with a valid account, that account information can be used to determine the type of access permissible to perform one or more operations associated with the request. In some embodiments, an access control manager 112 may work with a resource manager 110 to determine a specific instance of a type of resource 114 to be used to perform an operation with respect to the request, whereas the resource manager 110 can perform other types of operations as needed, such as to allocate additional capacity of a type of resource, launch a new compute instance, or perform another such task associated with the request.

In many instances, a request that involves a number of operations to be performed may have those operations, or portions of those operations, distributed across a set of processing resources. This may include distribution across a number of physical compute resources, such as a set of shared servers, and/or may include multiple processing resources (physical or virtual) within a given physical resource. As an example, FIG. 1A illustrates example components that may be found within a given server 122 that may be allocated to perform one or more processing tasks with respect to a request. The server 122, in this instance, is illustrated to contain different types of processing units, including one or more central processing units (CPUs) 124A-N, one or more graphics processing units (GPUs) 126A-N, and one or more data processing units 128A-N, as may be interconnected using at least one internal bus 134. At least the DPUs 128A-N in this example may be connected to local storage 130 in the server, as well as at least one remote storage instance 132 that may be external to the server but within the shared resource environment 106. CPUs 124A-N are often used for tasks such as single threaded user applications, and GPUs 126A-N are often used to perform multiple small but related operations in parallel. DPUs can be used to offload processing tasks from these CPUs and GPUs that may not optimally be performed on these processing units, as may related to heterogeneous data-centric processing tasks that can benefit from a different type of accelerated processing. A DPU is a programmable processor or system-on-chip, which combines one or more multi-core, high-performance CPUs, a set of acceleration engines that can offload and improve performance for data-centric tasks, and one or more high-performance interfaces capable of parsing, processing, and efficiently transferring data at high speeds. A DPU can be used as a stand-alone embedded processor, or can be incorporated into a smart network interface card (SmartNIC) in a server, among other such options.

In at least one embodiment, a datacenter 150 may include one or more rooms 152 having racks 154 and auxiliary equipment to house one or more servers 170 on one or more server trays, as well as graphics processing units (GPUs) 156 and other such components. In at least one embodiment, a datacenter 150 is supported by a cooling tower located external to the datacenter 150. A cooling tower can dissipate heat from within a datacenter 150 by acting on a primary cooling loop 166. In at least one embodiment, a cooling distribution unit (CDU) 162 is used between a primary cooling loop 166 and a secondary cooling loop, or other such heat removal mechanism.

A resource manager 172 (or datacenter manager, etc.) can monitor information about such a datacenter 150, including information about the operation of any or all of these components, including individual servers 170 as well as racks or pods of servers, as well as individual components of those servers, such as connections, LEDs, cables, and the like. The resource monitor can also monitor components related to networking, cooling, and other systems used to ensure proper operation of the datacenter 150. This can include receiving and analyzing metric or health information reported by the various components. In some embodiments, there may be sensor assemblies 168 used as discussed in more detail elsewhere herein that can also capture and provide information about these components, as may be captured using one or more sensors.

As mentioned, datacenters such as that illustrated in FIGS. 1A and 1B are becoming increasingly more sophisticated and complex, comprised of larger server systems that have more connections, interfaces, and potential points of failure than ever before. Approaches in accordance with various embodiments can attempt to determine the physical state of various components by, in part, capturing visual information about various components in a datacenter. Such visual information can include image data, as may include a sequence of images captured over time, one or more single images, segments of video data, stereoscopic image data, or image data with depth information, among other such options. Such visual information may also include other types of “image data,” as may include point cloud data, LiDAR data, mesh data, and other such options which may provide at least some visual information about the state of one or more components. Other types of data may be captured using various sensors as well as discussed in more detail elsewhere herein, as may relate to audio, heat, odor, air flow, and other such data. Such information, once captured or otherwise obtained, can be used to attempt to determine or infer whether there are any identifiable and/or potential issues determinable from the captured information. The analysis can be performed using, for example, a computing system or artificial intelligence (AI) actor. An “AI actor,” as used herein, refers to a system, service, module, or process that can receive and process information, using AI, and provide or perform recommended actions in response. This can include, in at least one embodiment, an AI actor generating and/or processing queries, and generating answers, responses, or recommendations with respect to components detectable in the captured information. Such an approach can involve use of at least one language-based model, such as a large language model (LLM) and/or vision language model (VLM), that can generate and/or accept such queries (or prompts), and can generate answers or inferences in response. When analyzing computing resources that might be present in a datacenter, for example, prompts might be generated to query a language model (trained on datacenter operation characteristics, states, and other such training data) as to what servers of a particular type should look like, if the connections for this type of server look correct, or if the system is healthy, among other such questions. As discussed with respect to FIG. 1B, such image data can include a significant amount of information that can be helpful to answer these types of questions.

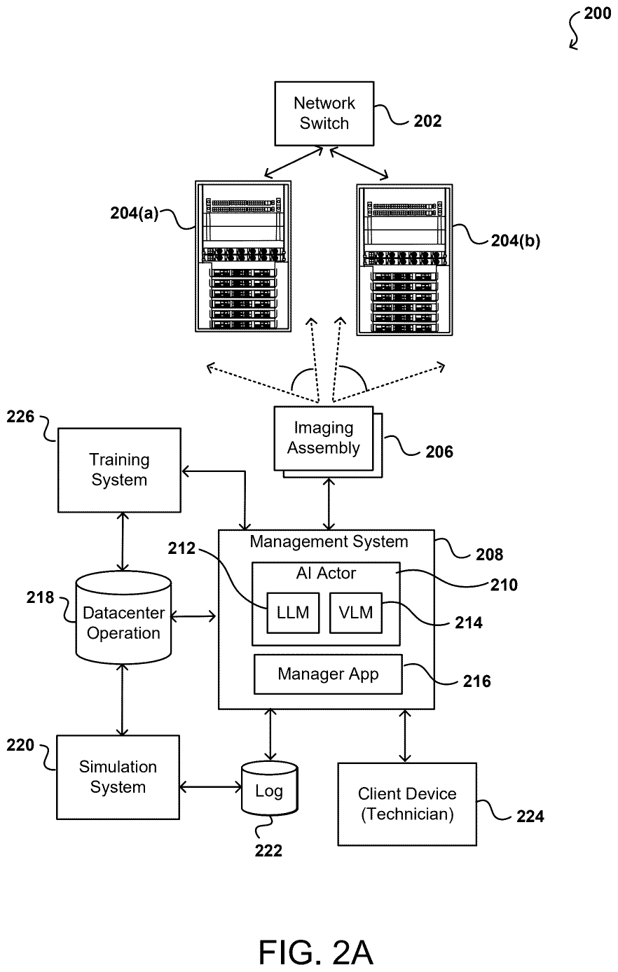

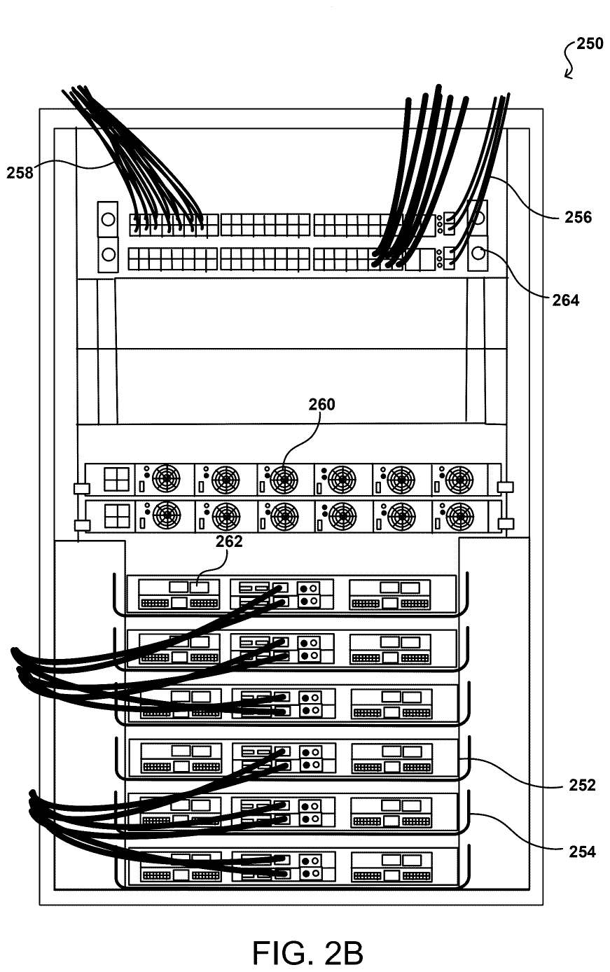

FIG. 2 illustrates an example system 200 that can be used to provide automated intelligence in a datacenter, according to at least one embodiment. In such an environment, there may be various components, such as racks 204(a)-(b) of servers and networking components such as a network switch 202, for example, that are used to perform various operations. One or more imaging assemblies 206 can be used to capture image data with respect to at least some of these components. In at least one embodiment, an imaging assembly 206 can capture image data for one or more locations or components in a datacenter that are determined to potentially be related to a specific issue in the datacenter, or may capture image data periodically for a set of components as part of a routine maintenance procedure, among other such options. The image data can be captured using one or more cameras or imaging sensors at a particular location, orientation, and zoom level (or other such settings) to obtain a field of view that includes one or more features or component of interest, an in at least one embodiment may contain several components in a single image. The amount of information represented in a single image may be a factor of the necessary resolution needed to properly identify and distinguish components, while also attempting to minimize the amount of image data that needs to be processed to conserve time and resources.

At least a portion of the captured image data can be provided to a management system 208 to attempt to determine the state, condition, or configuration of various components. An example implementation can involve use of an AI-based analytical sub-system, such as an AI actor 210, which may work together with a manager application 216 to perform management tasks for a set of components. An AI actor 210 can take advantage of one or more large language models, such as a large language model (LLM) 212 and/or vision language model (VLM) 214, that provides context and language capabilities. Such models can be used to query, provide inferences, and/or even train (by a training system 226 having access to datacenter operational data) an automated AI actor 210 to perform tasks such as to ask questions and/or generate responses appropriate for a given situation and environment. Instead of relying on conventional language-based learning, however, approaches in accordance with various embodiments can redefine and/or expand the language used by these models to include physical language, as may be specific to a datacenter, server farm, or other such resource environment. In at least one embodiment, such language can be used to describe the physical state of a computing system, for example, including the state or pattern of various LEDs, the positioning of various cables, the state or location of various power connections or sources, and other such aspects, as will be discussed in more detail with respect to FIG. 2B. A language model (e.g., an LLM 212 and/or VLM 214) can use such language to describe the physical operational state of a datacenter. There can be various contextual information available, similar to the body language of a person speaking that helps add context to the content of their actual speech, that can be captured and used to make more accurate determinations and predictions.

In at least one embodiment, an AI model can be trained to understand not only the language of queries that a user or application might provide, but can also be trained to understand the language of physical behavior and physical state in a datacenter or other such environment. The trained AI can then use that information in essentially the same way that language would be used. In one example, physical state information can be used in conjunction with logged state information. An AI actor 210, for example, could be able to access various state logs from a log database 222, for example, similar to the way in which a debug engineer might attempt to diagnose a problem. Where a human actor might go through a rules-based decision tree to attempt to diagnose the problem, a trained AI actor 210 can use its learning with available contextual and historical state data, as may be stored to a datacenter operation repository 218, to infer a digital and/or physical response, as may otherwise only be available to a human user who is present in the appropriate location in the datacenter. An AI actor 210 can thus use visual information with potential language queries and historical data to interpret and infer aspects of a current operational state.

In this example, image data (and potentially other relevant data) that is captured for one or more components can be received to a management system 208, then provided to an AI actor for analysis. It might be the case that the management system 208 first detects a potential issue with the datacenter resources, and contacts the AI actor 210 that can cause the appropriate image information to be captured by one or more corresponding imaging assemblies 206. In one embodiment, the AI actor 210 can use a first machine learning model (e.g., a VLM 214) to analyze at least a portion of the captured image data and output a set of information (e.g., a textual description) about the represented datacenter component(s), such as may be encoded into a latent space and/or feature vector. A second AI model, such as a large language model (LLM) 212, may then receive a prompt with a question or query about the component(s), and may use the generated textual description of the current state, as may be represented by a point in latent space or a feature vector, to infer an appropriate response. This can include, for example, comparing the generated textual description of the current state against the historical and/or expected operational data extracted from the datacenter operation repository 218. In another embodiment, the image data may be input to a trained vision language model (VLM) that can analyze the input image data and generate a response to a query or prompt without the need for a second model, such as a separate LLM 212, among other such possibilities. Such an AI actor can process received queries, such as from the management system 208 or a client device 224 as input by a technician, or may automatically generate queries for further data gathering or analysis, among other such options. In at least some embodiments, some of the additional data gathering or sending of notifications can be performed by the manager application 216 upon receiving results or instructions from the AI actor 210.

In one example, a camera may be used to capture images and/or video of the state of a server 250 over a period of time, such as one of a number of servers illustrated in an example set 250 of server system components of FIG. 2B. A camera may be caused to capture image data for an entire server rack 250, a server tray 254, an individual server 252, or specific components on, part of, or in connection with a server 252 or other such device. This may include, for example, cabling or tubing 256, communication fibers 266, LEDs 258, fans 260, connectors or ports 262, 264, liquid cooling connections or manifolds, and other such components. As mentioned, at any given time, there will be at least a subset of these components that need to be connected and/or functioning in a particular way for the system to be performant. Many of these components have expected feedback mechanisms or characteristics such as light emitting diodes (LEDs), displays, labels, pullout tabs, cable colors, latches, levers, liquid connections, elevations within the rack, and expectations on how much bend and/or bow in the sheet metal is acceptable. Each of these and other such physical mechanisms or characteristics can contain information on the likely health of the device. Image data can be captured to determine at least some of the relevant state, connection, and/or configuration information as discussed herein. This can include “static” information such as the cables connected to a server or the placement of specific components, where “static” here represents things that are able to change but tend to remain unchanged over long periods of time, and as such are likely to remain unchanged over the period of imaging. Such image data can also include variable or dynamic information, such as the behavior of lights (e.g., LEDs) that may blink or change color over time, spinning of fan blades that may change speed or active state, and so on. The captured image data can include ambient light with wavelengths over a humanly-visible spectrum, for example, or can contain infrared (IR) or ultraviolet (UV) image data representing light at wavelengths over the respective spectrums, as may be useful for heat mapping and other such purposes. A light filtered sensor might be used for purposes such as leak detection, air movement, or temperature variations over time. In some embodiments at least some of this and other such information may be obtained from other sources, such as system telemetry data or monitoring data.

The image data can include a representation of one or more components functioning at, for example, full capacity and performance. If that server system were to become non-performant, or to experience a failure, error, alarm state, or other such issue, a manual actor or AI actor could gather new imagery representing the current operational state of the server system. The actor can then generate new, specific queries based in part on the captured image data, error information, and/or other relevant data.

In at least one embodiment, image data might be captured (or caused to be captured) after detection of a problem (or a potential problem). For example, a datacenter AI actor might detect (or infer) that a specific network interface is intermittently connecting and disconnecting. The AI actor (or the result produced by the AI actor) can then cause or trigger a camera to bring the relevant server or component into a field of view so that the camera data can capture a sequence of images or video of the operation of that server or component over a period of time. This may include, for example, activating a camera that is already directed toward a relevant server, or causing a nearby camera to focus on the relevant server. If there is an automated camera assembly on the server, a corresponding server rack, or in another nearby location, that camera can be moved into position to capture the appropriate image information. In other embodiments, a robotic assembly may be moved from a different physical location in a datacenter into position to be able to capture the relevant image information, among other such options.

In at least one embodiment, an AI actor (such as that described with respect to FIG. 2A) can have access to a healthy video sample of the same component and/or systems, as may be obtained from a datacenter operation data repository or other such source. The AI actor can compare the recently captured video data against the historical video data representing a healthy, normal, or expected operation during a similar state or configuration. The AI actor can, through its own learning and intelligence, generate a set of differences in visual behavior. In one example, an AI actor might detect that the blinking pattern of an LED associated with one of the ethernet networking ports differs between the current video and the historical video. Knowing and having trained on expected behaviors and failure mechanisms (i.e., the language of physical behavior of this type of system), the AI actor can determine that it needs go parse the specification on that LED pattern. Once the AI actor locates the specific pattern that is not being observed, the AI actor can report back to a management system, manager application, or system admin through a client device or administrator console that this particular server is not behaving correctly, or is at least behaving unexpectedly. The AI actor can also provide supporting and/or contextual information, such as the root cause appearing to be that an identified and specific cable has malfunctioned. The AI actor and/or management application can generate a report or log entry, which may include content such as images and/or video evidence demonstrating the specific pattern, as well as identifying information for the cable should be replaced, as well as the server to which the cable is connected, among other such options. In at least one embodiment, an automated robotic actor may be controlled by the AI actor and/or management system to correct the problem in-situ, should it be given permission to act in this way. In some embodiments there may be a different system or service that can control the robotic actor, and the AI actor can instead provide information that indicates the problem and/or solution, and can allow that system to instruct the robotic actor as appropriate.

In order to allow an AI actor to perform with at least acceptable performance in a variety of different circumstances, any models (e.g., LLM 212 or VLM 214 of FIG. 2A) to be used by the AI actor 210 will need to be properly trained and validated. Training by a training system 220 will generally involve collecting and/or generating a sufficiently large amount of training data that represents a variety of different operational states and configurations. This can include generating images (or video frames or segments, etc.) of components, such as servers, in various operational states or conditions. Example images can essentially function as non-iconic images of a rack of servers, for example, with various LED lights switched on or off, the optical cables connected in various locations, components installed in specific locations, and so on. The image data can include captured and labeled data (or at least captured data for specific states), and can also include synthetic data generated to represent the various components in specific states. The training data can then be used to train an AI or ML model, such as a foundation model, RAG, or image-based retrieval model. Such training images can be simulated from a physical perspective as well as with high fidelity images from any appropriate angle, zoom level, etc. For generated video or image sequences to be used for training, the data can be generated for any appropriate period of time, using any appropriate simulated camera motion.

In at least one embodiment, a simulation software, platform, or environment can be used to generate appropriate training data. An example of such an environment is Omniverse from NVIDIA Corporation. Such an environment can be used to create a digital twin of a datacenter, for example, and can recreate or reconstruct realistic operational states. Training data can then be used using at least one digital camera that can be placed at any location in the digital datacenter, to capture image data for any component in any potential operational state. This can include both expected and unexpected states, including examples of error states, alarms, and failures. Once the data is created (or otherwise obtained), the data can be split into training data, testing data, and validation data. Based in part on validation performance, additional data can be generated as appropriate, such as to address certain error conditions on which performance is low or insufficient. For testing before deployment, an AI agent and/or reinforcement learning agent can be developed whose goal is to generate images in various conditions, such as with random LED and optical cable conditions and combinations. Such validation at scale can be beneficial to ensure that unforeseen edge cases are discovered.

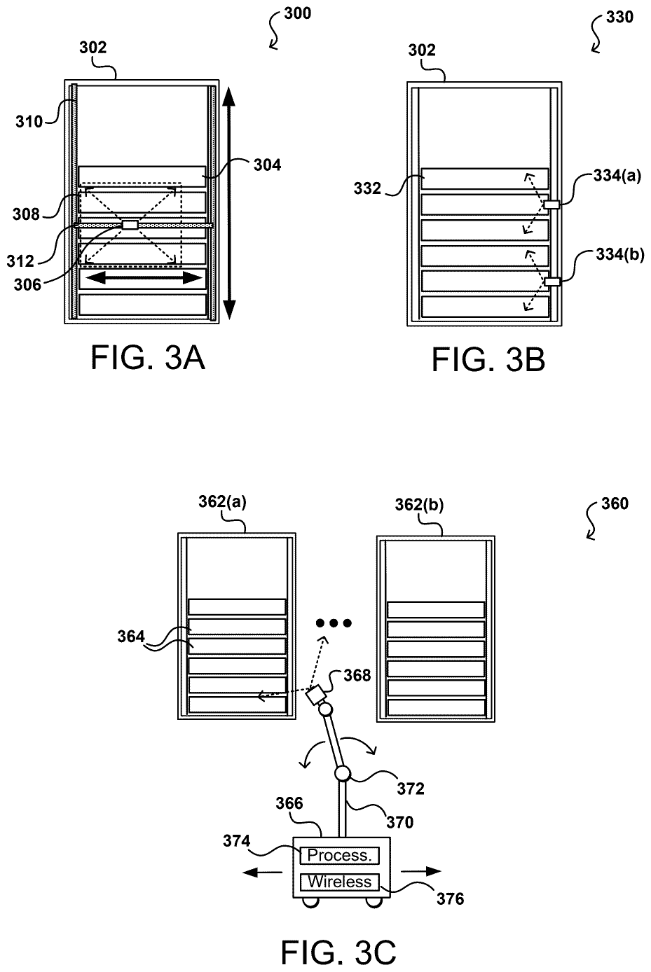

Image information can be captured for various components in a datacenter, or other such location, using a variety different types of cameras or imaging assemblies. FIGS. 3A, 3B, and 3C illustrate example camera assemblies that can be used to capture such information. Although illustrated with respect to one or more server racks, it should be understood that these and other types of assemblies can be used to capture image data for other types of components as well as discussed and suggested elsewhere herein. In the example view 300 of FIG. 3A, a server rack 302 is illustrated that includes a set of components, including a set of servers 304. The servers 304 are arranged in the server rack 302 such that the backs of the servers 304, where many connections, status lights, and other components of interest are typically positioned, will be facing in the same direction, such as towards an open back of the server rack. A camera 306 (or other imaging sensor or assembly) can be used to capture image data with respect to the back sides of the servers 304 in the rack. In this example, the camera 306 is positioned on a mechanical assembly including a horizontal track 312, allowing the camera to be moved horizontally with respect to the rack, and a pair of parallel vertical tracks 310, allowing the camera 306 to be moved vertically with respect to the rack. The ability to move the camera 306 in two dimensions allows a field of view 308 of the camera 306 to be translated such that any relevant portion of the backside of a component installed the server rack (and visible from a backside of the rack) can be captured in image data. The motion of the camera 306 along one or more of the tracks 310, 312 may be performed automatically, in order to cause the field of view to move to a determined location, or at least partially under human control, to allow a technician or other such person to be able to capture any image data determined to be of potential interest (or satisfying another such selection criterion, such as may be part of a routine maintenance schedule that requires periodic analysis of at least certain types of components). At least one motor or actuator (not shown) can be used to drive the motion. There may be such assemblies on other sides of a server rack as well, or multiple such cameras on a single side, among other such options.

FIG. 3B illustrates an example view 330 of another potential camera assembly that can be used according to at least one embodiment. In this example, instead of (or in addition to) having a translatable camera, there may be one or more fixed cameras 334(a)-(b) that are each positioned to capture image data over a respective field of view. A camera may be attached to a server, a server tray, a server rack, a network switch, a camera stand positioned proximate a component, or any other appropriate component or location. If a potential issue is detected that impacts a given component, such as a specific server 332, then a corresponding camera 334(a) that is positioned to be able to capture image information about that server 332 can be activated and/or caused to capture image information about that server 332. Cameras can be activated as needed, and only caused to capture image or video data when instructed, which can help to reduce power consumption, as well as to reduce the amount of image data to be processed, as image data will only be captured when provided, and only to the extent necessary to obtain image information for a respective component or set of components. Parameters of the camera can also be adjusted to limit the amount of unnecessary data captured. For example, if an image is to be captured to determine the state of a specific connection, then the camera can be caused to zoom in on that connection and capture a relatively small image focused on that connection (and potentially other relevant information, such as an identifier), rather than capturing image data for an entire server, rack, or server pod. Limiting image data to the component at issue can also help to ensure that the appropriate connection is analyzed without having to do a substantial amount of image analysis.

In some datacenters, it may be preferred to not have to install, maintain, and power a large number of small cameras, and to ensure that all important components have a camera able to capture image data representing those components. In such situations, an automated and/or robotic assembly 366 can be used, as illustrated in the example view 360 of FIG. 3C. In this example, a robotic assembly 366 can have wheels, tracks, legs, or other appropriate movement mechanisms that allow the robotic assembly to move throughout at least a portion of a datacenter, or other such environment. The robotic assembly 366 can have at least one camera 368 or imaging sensor that is able to capture image information about components within a view and/or proximity of the robotic assembly. In this example, a camera 368 is positioned at the end of a mechanical arm 370 that includes one or more controllable joints 372 to enable the camera to be positioned with respect to one or more components of interest, such as one or more servers 364 in one or more server racks 362(a)-(b), once the robotic assembly 366 is moved to an appropriate location near the component(s). The camera 368 can be moved to capture image data at different locations, or can capture video data while translating to different locations or changing orientation to capture different fields of view. The robotic assembly 366 may have to move to different locations to capture image data for different objects, based in part upon the relative locations of those components and the movement capabilities or limitations of the robotic arm 370 and camera 368. The robotic assembly can include one or more processing units 374 to provide for the capture and processing of image data, and a wireless communication system 376 allowing the image data (or results of processing the image data) to be transmitted to a remote location, such as a management system that can analyze the captured image data and determine whether additional image data is to be captured at the same location or at least one different location. The at least one processor unit 374 can also analyze instructions and cause one or more motors or drive assemblies of the robotic assembly 366 to move the camera to an appropriate location and orientation to capture a target set of image data. Various other camera and imaging assemblies and configurations can be used as well within the scope of various embodiments. In some embodiments, such a robot may not be fully automated but may be at least partially under control of a user through use of a control mechanism or control software, etc. In some embodiments, a human could also carry a device (such as a tablet computer or smartphone) that can include a camera to capture information about one or more components, which can then be transmitted for processing. Software on the mobile device can direct the user to the appropriate location, and provide indication of when a target component is within the field of view, when additional image information needs to be captured, etc.

In one example, a robotic assembly 366 could roll up to a rack to obtain information about one or more components of the rack. This could be in response to a potential error with the rack, or as part of a routine maintenance or monitoring process, among other such options. The robotic assembly 366 can move into sufficient proximity to a given rack, and can use a camera or imaging sensor (such as a QR scanner or bar code reader) to scan a code, such as a QR code or barcode, positioned on an exterior surface of the rack (or other appropriate location). The robotic assembly 366 can use the identifier or information in this code to obtain information for that particular rack, in addition to being able to determine an identity of that rack and ensure that any captured data is associated with the correct rack. In at least one embodiment, an application executing on the robotic assembly can use this identifier to obtain information about the rack, whether from the rack (or a component in the rack) or from a centralized location. The information can also be compared against a map of the datacenter and expected location of the robotic assembly 366 to ensure that components are in their expected locations.

Such an approach allows a robotic assembly to function like a human technician in a datacenter, and to perform at least some of the tasks that such a human would perform in such a location. Similar to how a human can walk up to a server rack and look at different components in the rack to gather information, a robotic assembly can move to a location near the rack and capture visual (or other) information about the components in the rack in order to assess the health or other aspects of those components. The gathered information can then be provided to a remote actor for analysis, such as by using at least one language model that is trained to understand this type of data. In one embodiment, a camera of a robotic assembly can capture image data of the back of a server rack, indicating the connections, light patterns performed using various LEDs, and so on. The remote actor can then attempt to determine if there is a problem with any components in the rack, as well as the potential cause for that problem. This can include accessing the logs and telemetry for the system to attempt to identify any error codes, alarms, or notifications that currently exist or were recently issued. In some embodiments, a camera can be used to capture a first set of information about a first set of components, and if additional information is needed can capture additional information about the same set or a different set of components. This may include other types of information than visual information as discussed elsewhere herein, and can allow the robotic assembly to physically troubleshoot a problem by starting with the most likely causes and then working to other potential causes as needed. The model(s) allow the AI actor to know, contextually and based on this physical language, whether a healthy rack is healthy or otherwise in an expected state for normal operation in a datacenter. An AI actor can contextually know, based on the physical language, what to expect from a healthy system and identify any of a number of potential anomalies. This may include, for example, a cable on a tray or server that is loose, unseated, or frayed, or an LED that is flashing an unexpected pattern. The AI actor can use contextual information that is based not only on the digital state of the system, but also the physical state. As mentioned, other types of physical information can be used as well, such as audio data captured by one or more microphones, IR image data captured by a heat sensor, humidity or temperature data from one or more sensors, scent data captured by a scent sensor (to detect the presence of smoke or fluid leaks), and so forth. In some embodiments, there may be information available through wireless communications, such as NFC or Bluetooth, that is available from a server or component without having to connect through a network connection, which can help to identify specific components and verify their placement. It should be mentioned, however, that at least some types of wireless communication may be excluded from use in a datacenter.

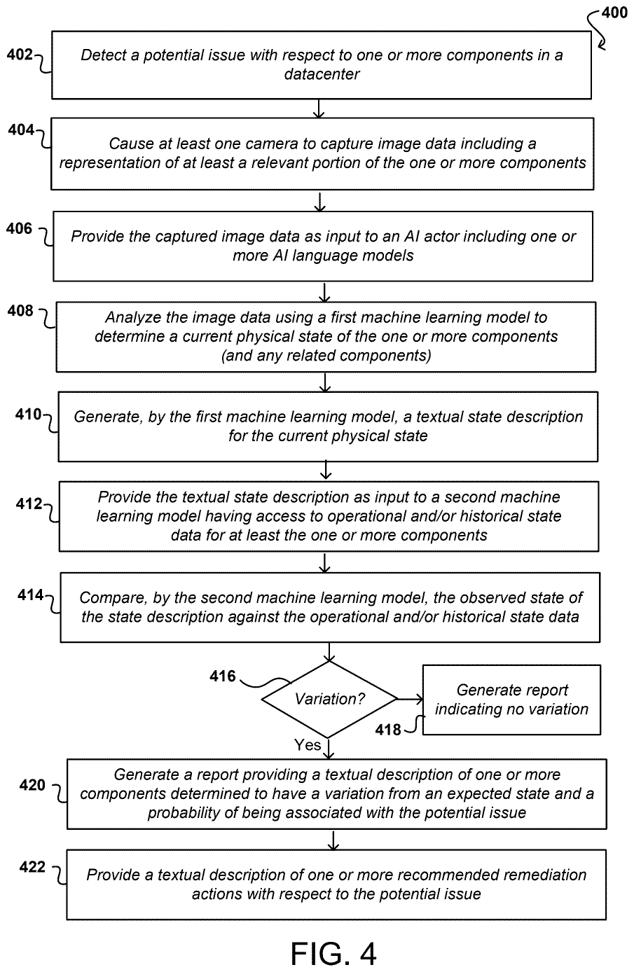

FIG. 4 illustrates an example process 400 that can be performed to automatically analyze and make intelligent decisions about one or more components in a datacenter, in accordance with at least one embodiment. It should be understood that for this and other processes discussed herein that there may be additional, fewer, or alternative steps performed in similar or alternative orders, or at least partially in parallel, within the scope of the various embodiments. Further, although discussed with respect to a datacenter and image data, it should be understood that advantages of such a process can be obtained for other types of input data as well—such as point cloud data or other types of sensor data—in other types of computing or resource environments as well, within the scope of various embodiments. In this example process, a potential issue is detected 402 with respect to one or more components in a datacenter. As mentioned, in some embodiments subsequent steps can be performed without first detecting a potential issue, as part of a preventative maintenance routine. At least one camera can then be caused 404 to capture image data including a view of at least a relevant portion of one or more components that may be associated with the potential issue. This may include, for example, capturing image data or video representing the back of a server, including connections, lights, switches, or other potentially relevant components that may be associated with the potential issue. The image data (or video, etc.) can be provided 406 as input to an AI actor to attempt to determine whether the state of any of the components represented in the captured image data differ from an expected state. As mentioned, this can include determining the state of various components, and then comparing that state against the state determined for similar components in a properly operating datacenter. The image data can be analyzed 408 using a first machine learning model to determine a current physical state for one or more components. This physical state may include a combination of information, for example, as may include installation location, orientation, current connection(s), light state or pattern, and/or component identifier, among other such options. A textual state description for the physical state can be generated 410 by the first machine learning model. The state description can be provided 412 as input to a second machine learning model having access to operational and/or historical state data for the one or more components. Operational data can reflect the expected operation of a datacenter, for example, while historical data may represent previously observed states for proper and/or improper operation of a datacenter. The second machine learning model can compare 414 the observed state in the state description against the operational and/or historical data to attempt to identify one or more differences between the state description and the operational and/or historical data. As mentioned, in some embodiments a single machine learning model can be used that is able to analyze the image information and compare the results against the operational and/or historical data to identify such differences.

A determination can be made 416 as to whether at least one variation was detected that has at least a minimum probability of being associated with a detected or predicted issue in the datacenter. The minimum probability may be a threshold that is user adjustable, and may vary based on the type of issue and/or component, among other such issues. A lower probability threshold can result in a larger number of potential causes being identified, while a higher probability allows information to be conveyed for only those components with a relatively high likelihood of being associated with a potential issue, which can save time and resources but may also occasionally miss reporting actually impactful variations. In this example, if it is determined 416 that there is no such variation then a report (or notification, etc.) can be generated 418 indicating that there was no detected variation. A troubleshooting process may then be initiated that looks for other potential causes, such as causes in software, bandwidth, or power stability. If, in this example, it is determined 416 that there is at least one such variation, then a second machine learning model can generate 420 a report providing a textual indication and/or description of one or more components in the datacenter that were determined to have a variation from an expected state, and where based in part on the learning of the machine learning model that variation has at least a minimum probability of being associated with the identified potential problem and/or a different or anticipated problem. For example, a variation might be detected where a server identification sticker was not placed in the correct location but a few inches to the right, but such variation is unlikely to be associated with various faults so that variation may not be included in the report. If, on the other hand, a connector is detected to be loose or an LED is flashing a failure pattern, then that information can be included in the report, as may include a technical description of the location, identification, observed problem, and/or potential impact on the problem. In at least one embodiment, the second machine learning model may also provide 422 (in the generated report or otherwise) one or more potential remediations for the identified variations, such as to securely plug in a connector, reboot a server, replace a frayed cable, and so on. For some remedial actions that are able to be made automatically—such as to reboot a server or take a server offline—those actions may be made automatically by a system manager or other such system or service, at least where permitted within that datacenter. Implementing such a process allows an AI actor to use image and/or visual data in tandem with contextual specifications on the datacenter and its components to generate LLM-style queries, as well as to act on the results in an intelligent way.

In at least some embodiments, a user (or application, etc.) may be able to query an AI actor for information about a system or component. For example, a user might type, speak, or otherwise provide a query such as “node X seems to be misbehaving, can you tell me what you think is going on?” The AI actor can determine, contextually via the learned physical language, what that query means. The AI actor may also need to determine certain current state or other physical information about the components that may be associated with the query. A language model used by the AI actor can be trained to determine what is meant by the query, or may use offloading or another trained model, to help determine information for the query. In a situation where a deployable model (such as may be deployed using an NVIDIA Inference Module (NIM) offered by NVIDIA Corporation) is available, the model may use such a dedicated model to make one or more necessary inferences. In some instances, a separate model might be trained to understand the various physical states of a specific system or set of components, including contextually how a given system should be behaving given the current state. The AI actor can then detect anomalies with respect to the expected physical state, and can make informed decisions as to what those anomalies may be, based on the prior triage information it has been trained on. Such models may be trained on synthetic data as well as real world data, in order to obtain a sufficient amount of information about a variety of physical states of a datacenter, for both expected and unexpected operation. For example a digital twin model of a datacenter can be used that can have specific states indicated that are related to specific issues, such as frayed power cords, proper or improper seating of a component in a tray, improperly oriented or placed connectors, incompletely latched latches, an unexpected number of cables, or the displaying of various LED light or pattern messages, among a variety of other such data. If an AI actor determines an anomaly related to the query, the AI actor can generate an appropriate language-based response to provide back to the user.

In some embodiments, an AI actor may also perform such tasks without first receiving a query or receiving information about a potential issue in a datacenter. A robotic assembly, when not performing a specific task, may be programmed to move about the datacenter and capture image (and other such) data about various components, as part of a maintenance or monitoring process. A robotic assembly can capture physical state data about a component that can be analyzed to determine if any anomalies are present. For example, a cable may become unseated or frayed, or a power light on a server component might start flickering, which may indicate a potential problem that should be at least investigated before a more serious problem occurs. For certain issues, the AI actor can generate some type of notification that can be provided to a human technician or other such responsible person. If the robotic assembly has the appropriate physical capabilities, such as may include one or more arms and end effectors, the robotic assembly may attempt to remedy the situation, such as by plugging a cable back in or replacing a frayed cable. If the AI actor identifies an anomaly, the AI actor may also instruct the robotic assembly to capture more physical state information to help the AI actor attempt to diagnose the problem and/or cause. Such an approach may also help to identify changes that may not seem problematic, such as where there has been a change in cabling or components. If such a change is detected, the AI actor can check a change log or other such location to determine whether the change was an intended change that was performed as instructed, and if not can raise an alarm or generate a notification for a human to investigate. Such an approach can help to improve an overall security of the datacenter by identifying changes that might seem normal but can be identified as unexpected, unanticipated, or otherwise suspicious, such as where someone might swap out a component for a compromised component. This may also include physical changes such as a seal on a server or switch being broken, indicating that someone may have tampered with the component.

An AI actor can identify physical anomalies for other components in a datacenter as well, such as networking switches and routers. In one example, there may be a network cable plugged in but an associated LED is flashing in a way that is unexpected for the current physical state. An AI actor can attempt to obtain data from this network switch or a related component, and/or can attempt to obtain related telemetry data or log information that may be helpful in understanding the state of the switch. In some instances, there may be a problem with the switch that needs to be addressed. In others, there may be new firmware on the switch that uses a new LED pattern such that there is nothing wrong with the switch, but the expected state options should be updated or learned. In such a situation, the AI actor may take no action other than to log the information and provide information about the change that can be used to further train the appropriate model(s). If the AI actor is not sure whether the behavior is expected, such as where there has been a firmware change but there is no information about the new pattern, the AI actor could submit a bug report or similar notification for someone to investigate.

### Datacenter

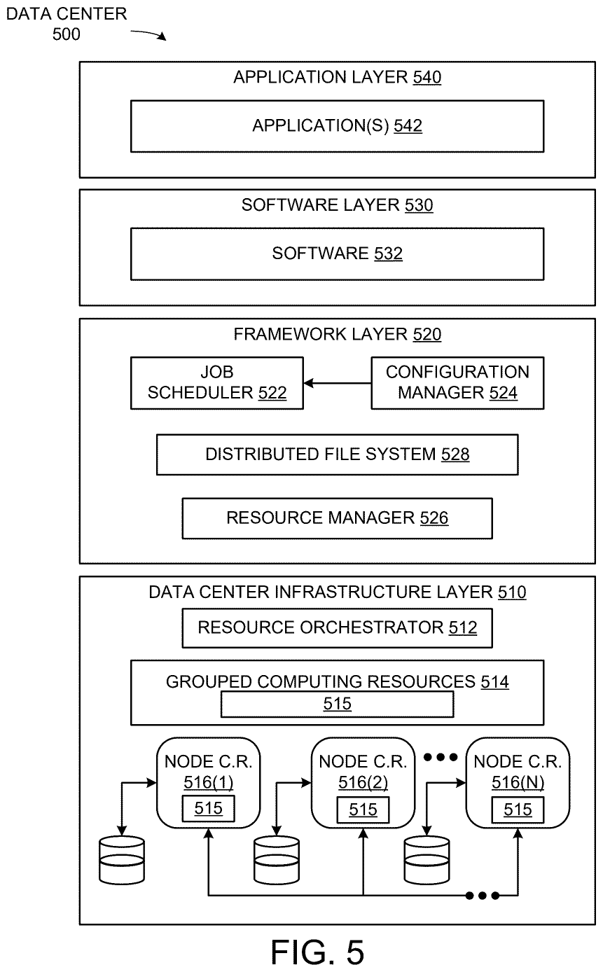

FIG. 5 illustrates the architecture of an example datacenter 500, in which at least one embodiment may be implemented. In at least one embodiment, data this center 500 includes a datacenter infrastructure layer 510, a framework layer 520, a software layer 530 and an application layer 540.

In at least one embodiment, as shown in FIG. 5, datacenter infrastructure layer 510 may include a resource orchestrator 512, grouped computing resources 514, and node computing resources (“node C.R.s”) 516(1)-516(N), where “N” represents a positive integer (which may be a different integer “N” than used in other figures). In at least one embodiment, node C.R.s 516(1)-516(N) may include, but are not limited to, any number of central processing units (“CPUs”) or other processors (including accelerators, field programmable gate arrays (FPGAs), graphics processors, etc.), memory storage devices 518(1)-518(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 516(1)-516(N) may be a server having one or more of above-mentioned computing resources.

In at least one embodiment, grouped computing resources 514 may include separate groupings of node C.R.s housed within one or more racks (not shown), or many racks housed in datacenters at various geographical locations (also not shown). In at least one embodiment, separate groupings of node C.R.s within grouped computing resources 514 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 512 may configure or otherwise control one or more node C.R.s 516(1)-516(N) and/or grouped computing resources 514. In at least one embodiment, resource orchestrator 512 may include a software design infrastructure (“SDI”) management entity for datacenter 500. In at least one embodiment, resource orchestrator 512 may include hardware, software or some combination thereof.

In at least one embodiment, as shown in FIG. 5, framework layer 520 includes a job scheduler 522, a configuration manager 524, a resource manager 526 and a distributed file system 528. In at least one embodiment, framework layer 520 may include a framework to support software 532 of software layer 530 and/or one or more application(s) 542 of application layer 540. In at least one embodiment, software 532 or application(s) 542 may respectively include web-based service software or applications, such as those provided by Amazon Web Services, Google Cloud and Microsoft Azure. In at least one embodiment, framework layer 520 may be, but is not limited to, a type of free and open-source software web application framework such as Apache Spark™ (hereinafter “Spark”) that may utilize distributed file system 528 for large-scale data processing (e.g., “big data”). In at least one embodiment, job scheduler 522 may include a Spark driver to facilitate scheduling of workloads supported by various layers of datacenter 500. In at least one embodiment, configuration manager 524 may be capable of configuring different layers such as software layer 530 and framework layer 520 including Spark and distributed file system 528 for supporting large-scale data processing. In at least one embodiment, resource manager 526 may be capable of managing clustered or grouped computing resources mapped to or allocated for support of distributed file system 528 and job scheduler 522. In at least one embodiment, clustered or grouped computing resources may include grouped computing resources 514 at datacenter infrastructure layer 510. In at least one embodiment, resource manager 526 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 528 of framework layer 520. In at least one embodiment, one or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 528 of framework layer 520. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 524, resource manager 526, and resource orchestrator 512 may implement any number and type of self-modifying actions based on any amount and type of data acquired in any technically feasible fashion. In at least one embodiment, self-modifying actions may relieve a datacenter operator of datacenter 500 from making possibly bad configuration decisions and possibly avoiding underutilized and/or poor performing portions of a datacenter.

In at least one embodiment, datacenter 500 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to datacenter 500. In at least one embodiment, trained machine learning models corresponding to one or more neural networks may be used to infer or predict information using resources described above with respect to datacenter 500 by using weight parameters calculated through one or more training techniques described herein.

In at least one embodiment, datacenter may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 5 for inferencing or predicting operations based, at least in part, on weight parameters calculated using neural network training operations, neural network functions and/or architectures, or neural network use cases described herein.

Embodiments presented herein can provide for automated detection of issues in a datacenter through a capture and analysis of image data using at least one language model or AI actor.

### Computer Systems

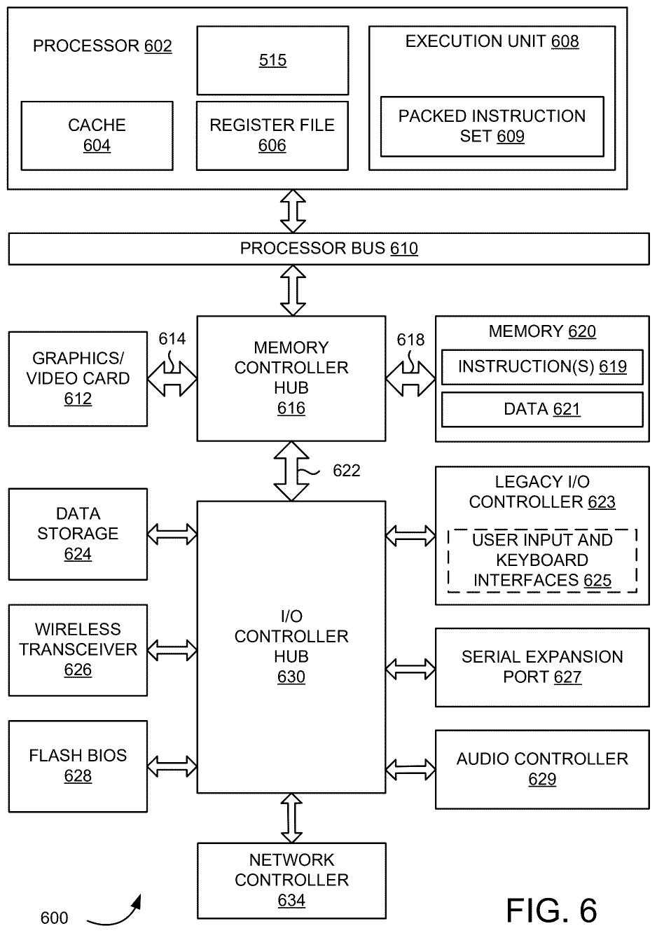

FIG. 6 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 600 may include, without limitation, a component, such as a processor 602 to employ execution units including logic to perform algorithms for process data, in accordance with present disclosure, such as in embodiment described herein. In at least one embodiment, computer system 600 may include processors, such as PENTIUM® Processor family, Xeon™, Itanium®, Scale™ and/or StrongARM™, Intel® Core™, or Intel® Nirvana™ microprocessors available from Intel Corporation of Santa Clara, California, although other systems (including PCs having other microprocessors, engineering workstations, set-top boxes and like) may also be used. In at least one embodiment, computer system 600 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“Necks”), set-top boxes, network hubs, wide area network (“WAN”) switches, or any other system that may perform one or more instructions in accordance with at least one embodiment.

In at least one embodiment, computer system 600 may include, without limitation, processor 602 that may include, without limitation, one or more execution units 608 to perform machine learning model training and/or inferencing according to techniques described herein. In at least one embodiment, computer system 600 is a single processor desktop or server system, but in another embodiment, computer system 600 may be a multiprocessor system. In at least one embodiment, processor 602 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 602 may be coupled to a processor bus 610 that may transmit data signals between processor 602 and other components in computer system 600.

In at least one embodiment, processor 602 may include, without limitation, a Level 1 (“L1”) internal cache memory (“cache”) 604. In at least one embodiment, processor 602 may have a single internal cache or multiple levels of internal cache. In at least one embodiment, cache memory may reside external to processor 602. Other embodiments may also include a combination of both internal and external caches depending on particular implementation and needs. In at least one embodiment, a register file 606 may store different types of data in various registers including, without limitation, integer registers, floating point registers, status registers, and an instruction pointer register.

In at least one embodiment, execution unit 608, including, without limitation, logic to perform integer and floating point operations, also resides in processor 602. In at least one embodiment, processor 602 may also include a microcode (“code”) read only memory (“ROM”) that stores microcode for certain macro instructions. In at least one embodiment, execution unit 608 may include logic to handle a packed instruction set 609. In at least one embodiment, by including packed instruction set 609 in an instruction set of a general-purpose processor, along with associated circuitry to execute instructions, operations used by many multimedia applications may be performed using packed data in processor 602. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 608 may also be used in microcontrollers, embedded processors, graphics devices, DSPs, and other types of logic circuits. In at least one embodiment, computer system 600 may include, without limitation, a memory 620. In at least one embodiment, memory 620 may be a Dynamic Random Access Memory (“DRAM”) device, a Static Random Access Memory (“SRAM”) device, a flash memory device, or another memory device. In at least one embodiment, memory 620 may store instruction(s) 619 and/or data 621 represented by data signals that may be executed by processor 602.

In at least one embodiment, a system logic chip may be coupled to processor bus 610 and memory 620. In at least one embodiment, a system logic chip may include, without limitation, a memory controller hub (“MCH”) 616, and processor 602 may communicate with MCH 616 via processor bus 610. In at least one embodiment, MCH 616 may provide a high bandwidth memory path 618 to memory 620 for instruction and data storage and for storage of graphics commands, data, and textures. In at least one embodiment, MCH 616 may direct data signals between processor 602, memory 620, and other components in computer system 600 and to bridge data signals between processor bus 610, memory 620, and a system I/O interface 622. In at least one embodiment, a system logic chip may provide a graphics port for coupling to a graphics controller. In at least one embodiment, MCH 616 may be coupled to memory 620 through high bandwidth memory path 618 and a graphics/video card 612 may be coupled to MCH 616 through an Accelerated Graphics Port (“AGP”) interconnect 614.

In at least one embodiment, computer system 600 may use system I/O interface 622 as a proprietary hub interface bus to couple MCH 616 to an I/O controller hub (“ICH”) 630. In at least one embodiment, ICH 630 may provide direct connections to some I/O devices via a local I/O bus. In at least one embodiment, a local I/O bus may include, without limitation, a high-speed I/O bus for connecting peripherals to memory 620, a chipset, and processor 602. Examples may include, without limitation, an audio controller 629, a firmware hub (“flash BIOS”) 628, a wireless transceiver 626, a data storage 624, a legacy I/O controller 623 containing user input and keyboard interfaces 625, a serial expansion port 627, such as a Universal Serial Bus (“USB”) port, and a network controller 634. In at least one embodiment, data storage 624 may comprise a hard disk drive, a floppy disk drive, a CD-ROM device, a flash memory device, or other mass storage device.

In at least one embodiment, FIG. 6 illustrates a system, which includes interconnected hardware devices or “chips”, whereas in other embodiments, FIG. 6 may illustrate an exemplary SoC In at least one embodiment, devices illustrated in FIG. 6 may be interconnected with proprietary interconnects, standardized interconnects (e.g., PCIe) or some combination thereof. In at least one embodiment, one or more components of computer system 600 are interconnected using compute express link (CXL) interconnects.

Inference and/or training logic 515 are used to perform inferencing and/or training operations associated with one or more embodiments. In at least one embodiment, inference and/or training logic 515 may be used in system FIG. 6 for inferencing or predicting operations based, at least in part, on weight parameters calculated using neural network training operations, neural network functions and/or architectures, or neural network use cases described herein.

Embodiments presented herein can provide for automated detection of issues in a datacenter through a capture and analysis of image data using at least one language model or AI actor.

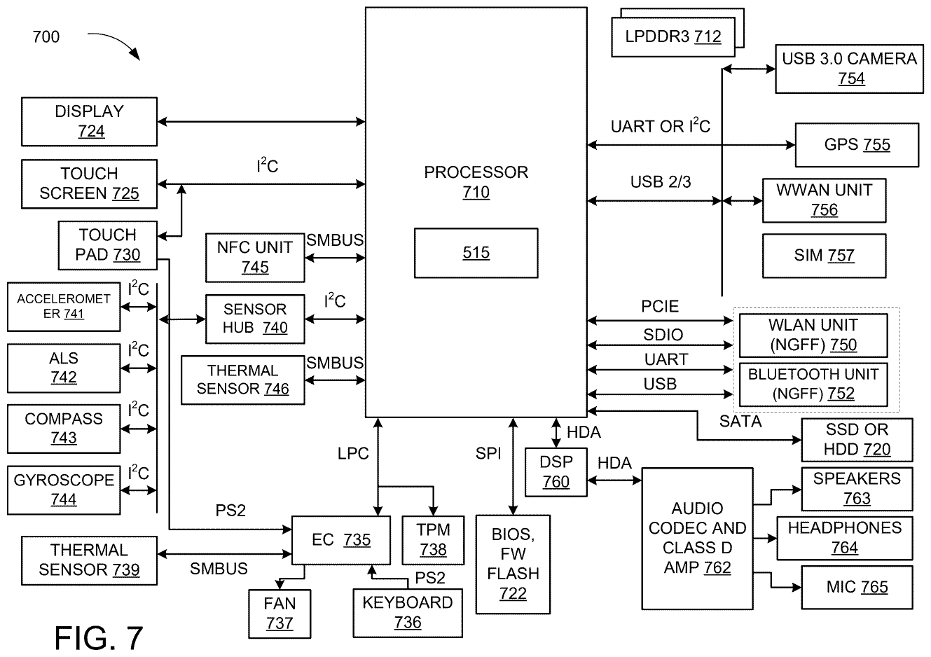

FIG. 7 is a block diagram illustrating an electronic device 700 for utilizing a processor 710, according to at least one embodiment. In at least one embodiment, electronic device 700 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 700 may include, without limitation, processor 710 communicatively coupled to any suitable number or kind of components, peripherals, modules, or devices. In at least one embodiment, processor 710 is coupled using a bus or interface, such as a I²C bus, a System Management Bus (“Sambas”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3, etc.), or a Universal Asynchronous Receiver/Transmitter (“UART”) bus. In at least one embodiment, FIG. 7 illustrates a system, which includes interconnected hardware devices or “chips”, whereas in other embodiments, FIG. 7 may illustrate an exemplary SoC. In at least one embodiment, devices illustrated in FIG. 7 may be interconnected with proprietary interconnects, standardized interconnects (e.g., PCIe) or some combination thereof. In at least one embodiment, one or more components of FIG. 7 are interconnected using compute express link (CXL) interconnects.

In at least one embodiment, FIG. 7 may include a display 724, a touch screen 725, a touch pad 730, a Near Field Communications unit (“NFC”) 745, a sensor hub 740, a thermal sensor 746, an Express Chipset (“EC”) 735, a Trusted Platform Module (“TPM”) 738, BIOS/firmware/flash memory (“BIOS, FW Flash”) 722, a DSP 760, a drive 720 such as a Solid State Disk (“SSD”) or a Hard Disk Drive (“HDD”), a wireless local area network unit (“WLAN”) 750, a Bluetooth unit 752, a Wireless Wide Area Network unit (“WWAN”) 756, a Global Positioning System (GPS) unit 755, a camera (“USB 3.0 camera”) 754 such as a USB 3.0 camera, and/or a Low Power Double Data Rate (“LPDDR”) memory unit (“LPDDR3”) 715 implemented in, for example, an LPDDR3 standard. These components may each be implemented in any suitable manner.

In at least one embodiment, other components may be communicatively coupled to processor 710 through components described herein. In at least one embodiment, an accelerometer 741, an ambient light sensor (“ALS”) 742, a compass 743, and a gyroscope 744 may be communicatively coupled to sensor hub 740. In at least one embodiment, a thermal sensor 739, a fan 737, a keyboard 736, and touch pad 730 may be communicatively coupled to EC 735. In at least one embodiment, speakers 763, headphones 764, and a microphone (“mic”) 765 may be communicatively coupled to an audio unit (“audio codec and class D amp”) 762, which may in turn be communicatively coupled to DSP 760. In at least one embodiment, audio unit 762 may include, for example and without limitation, an audio coder/decoder (“codec”) and a class D amplifier. In at least one embodiment, a SIM card (“SIM”) 757 may be communicatively coupled to WWAN unit 756. In at least one embodiment, components such as WLAN unit 750 and Bluetooth unit 752, as well as WWAN unit 756 may be implemented in a Next Generation Form Factor (“NGFF”).

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

Embodiments presented herein can provide for automated detection of issues in a datacenter through a capture and analysis of image data using at least one language model or AI actor.

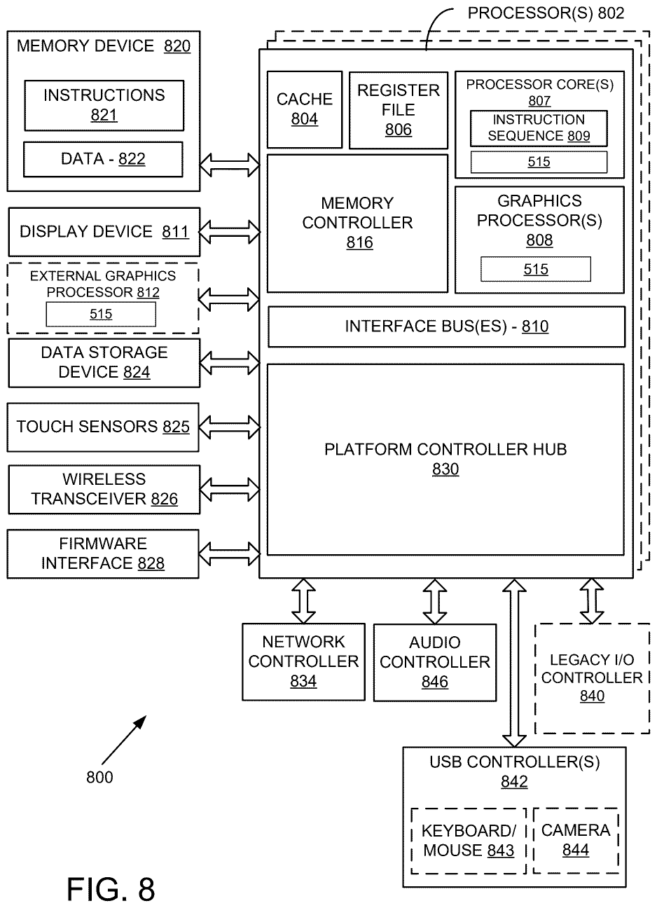

FIG. 8 is a block diagram of a processing system, according to at least one embodiment. In at least one embodiment, system 800 includes one or more processor(s) 802 and one or more graphics processor(s) 808, and may be a single processor desktop system, a multiprocessor workstation system, or a server system having a large number of processor(s) 802 or processor core(s) 807. In at least one embodiment, system 800 is a processing platform incorporated within a system-on-a-chip (SoC) integrated circuit for use in mobile, handheld, or embedded devices. In at least one embodiment, one or more graphics processor(s) 808 include one or more graphics cores.

In at least one embodiment, system 800 can include, or be incorporated within a server-based gaming platform, a game console, including a game and media console, a mobile gaming console, a handheld game console, or an online game console. In at least one embodiment, system 800 is a mobile phone, a smart phone, a tablet computing device or a mobile Internet device. In at least one embodiment, processing system 800 can also include, couple with, or be integrated within a wearable device, such as a smart watch wearable device, a smart eyewear device, an augmented reality device, or a virtual reality device. In at least one embodiment, processing system 800 is a television or set top box device having one or more processor(s) 802 and a graphical interface generated by one or more graphics processor(s) 808.

In at least one embodiment, one or more processor(s) 802 each include one or more processor core(s) 807 to process instructions which, when executed, perform operations for system and user software. In at least one embodiment, each of one or more processor core(s) 807 is configured to process a specific instruction sequence 809. In at least one embodiment, instruction sequence 809 may facilitate Complex Instruction Set Computing (CISC), Reduced Instruction Set Computing (RISC), or computing via a Very Long Instruction Word (VLIW). In at least one embodiment, processor core(s) 807 may each process a different instruction sequence 809, which may include instructions to facilitate emulation of other instruction sequences. In at least one embodiment, processor core(s) 807 may also include other processing devices, such a Digital Signal Processor (DSP).

In at least one embodiment, processor(s) 802 includes a cache memory 804. In at least one embodiment, processor(s) 802 can have a single internal cache or multiple levels of internal cache. In at least one embodiment, cache memory is shared among various components of processor(s) 802. In at least one embodiment, processor(s) 802 also uses an external cache (e.g., a Level-3 (L3) cache or Last Level Cache (LLC)) (not shown), which may be shared among processor core(s) 807 using known cache coherency techniques. In at least one embodiment, a register file 806 is additionally included in processor(s) 802, which may include different types of registers for storing different types of data (e.g., integer registers, floating point registers, status registers, and an instruction pointer register). In at least one embodiment, register file 806 may include general-purpose registers or other registers.

In at least one embodiment, one or more processor(s) 802 are coupled with one or more interface bus(es) 810 to transmit communication signals such as address, data, or control signals between processor(s) 802 and other components in system 800. In at least one embodiment, interface bus(es) 810 can be a processor bus, such as a version of a Direct Media Interface (DMI) bus. In at least one embodiment, interface bus(es) 810 is not limited to a DMI bus, and may include one or more Peripheral Component Interconnect buses (e.g., PCI, PCI Express), memory busses, or other types of interface busses. In at least one embodiment processor(s) 802 include an integrated memory controller 816 and a platform controller hub 830. In at least one embodiment, memory controller 816 facilitates communication between a memory device and other components of system 800, while platform controller hub (PCH) 830 provides connections to I/O devices via a local I/O bus.

In at least one embodiment, a memory device 820 can be a dynamic random access memory (DRAM) device, a static random access memory (SRAM) device, flash memory device, phase-change memory device, or some other memory device having suitable performance to serve as process memory. In at least one embodiment, memory device 820 can operate as system memory for system 800, to store data 822 and instructions 821 for use when one or more processor(s) 802 executes an application or process. In at least one embodiment, memory controller 816 also couples with an optional external graphics processor 812, which may communicate with one or more graphics processor(s) 808 in processor(s) 802 to perform graphics and media operations. In at least one embodiment, a display device 811 can connect to processor(s) 802. In at least one embodiment, display device 811 can include one or more of an internal display device, as in a mobile electronic device or a laptop device, or an external display device attached via a display interface (e.g., DisplayPort, etc.). In at least one embodiment, display device 811 can include a head mounted display (HMD) such as a stereoscopic display device for use in virtual reality (VR) applications or augmented reality (AR) applications.

In at least one embodiment, platform controller hub 830 enables peripherals to connect to memory device 820 and processor(s) 802 via a high-speed I/O bus. In at least one embodiment, I/O peripherals include, but are not limited to, an audio controller 846, a network controller 834, a firmware interface 828, a wireless transceiver 826, touch sensors 825, a data storage device 824 (e.g., hard disk drive, flash memory, etc.). In at least one embodiment, data storage device 824 can connect via a storage interface (e.g., SATA) or via a peripheral bus, such as a Peripheral Component Interconnect bus (e.g., PCI, PCI Express). In at least one embodiment, touch sensors 825 can include touch screen sensors, pressure sensors, or fingerprint sensors. In at least one embodiment, wireless transceiver 826 can be a Wi-Fi transceiver, a Bluetooth transceiver, or a mobile network transceiver such as a 3G, 4G, or Long Term Evolution (LTE) transceiver. In at least one embodiment, firmware interface 828 enables communication with system firmware, and can be, for example, a unified extensible firmware interface (UEFI). In at least one embodiment, network controller 834 can enable a network connection to a wired network. In at least one embodiment, a high-performance network controller (not shown) couples with interface bus(es) 810. In at least one embodiment, audio controller 846 is a multi-channel high definition audio controller. In at least one embodiment, system 800 includes an optional legacy I/O controller 840 for coupling legacy (e.g., Personal System 2 (PS/2)) devices to system 800. In at least one embodiment, platform controller hub 830 can also connect to one or more Universal Serial Bus (USB) controller(s) 842 connect input devices, such as keyboard and mouse 843 combinations, a camera 844, or other USB input devices.

In at least one embodiment, an instance of memory controller 816 and platform controller hub 830 may be integrated into a discreet external graphics processor, such as external graphics processor 812. In at least one embodiment, platform controller hub 830 and/or memory controller 816 may be external to one or more processor(s) 802. For example, in at least one embodiment, system 800 can include an external memory controller 816 and platform controller hub 830, which may be configured as a memory controller hub and peripheral controller hub within a system chipset that is in communication with processor(s) 802.

Embodiments presented herein can provide for automated detection of issues in a datacenter through a capture and analysis of image data using at least one language model or AI actor.

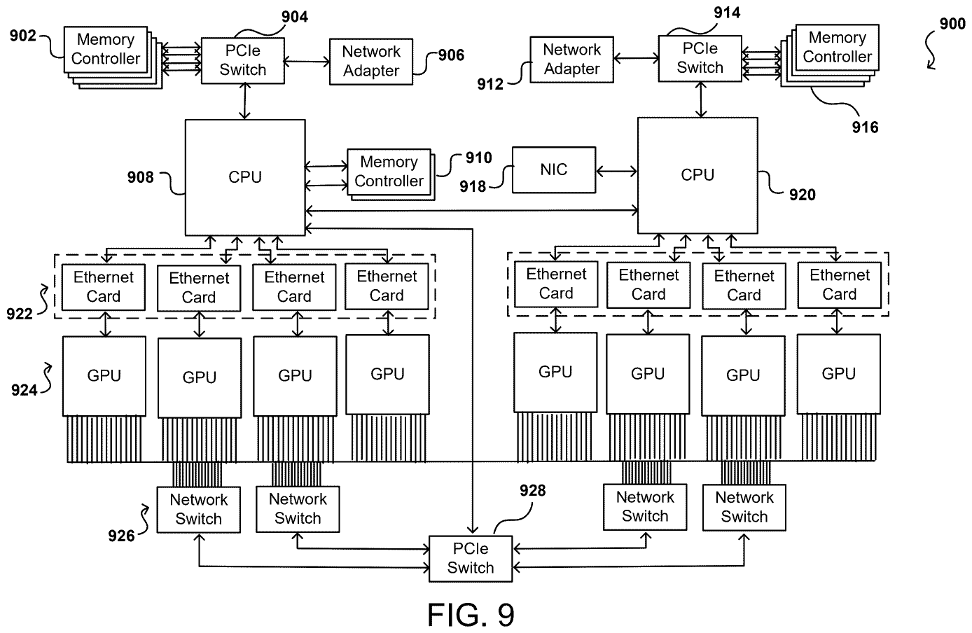

FIG. 9 illustrates an example enterprise AI system that can be used to perform at least AI-related tasks in accordance with at least one embodiment. An example of such a system is an H100 or H200 DGX system implementing the NVIDIA DGX™ platform from NVIDIA Corporation. The NVIDIA DGX™ H100/H200 Systems are built for all AI infrastructure and workloads from analytics to training to inference. The DGX H100/H200 systems are built on eight GPUs 924, such as NVIDIA H100 Tensor Core GPUs or eight NVIDIA H200 Tensor Core GPUs. Although not illustrated in FIG. 9, other types of processing units can be used as well, such as data processing units (DPUs). The illustrated system 900 includes a pair of CPUs 908, 920, such as Intel Xeon CPUs with 56 cores each. The CPUs 908, 920 are connected to the eight GPUs 924 using a set of Ethernet cards 922, such as ConnectX-7 Network Modules, which are connected in turn to a number of network switches 926, such as NVSwitches. The network switches 926 are connected to a PCIe switch 928, which can be connected back to at least one of the CPUs 908. A first CPU 908 can be connected directly to a memory controller 910, such as an NVMe controller, and to other memory controllers 902 indirectly through a PCIe switch 904, which can also connect the CPU 908 to a network adapter 906, such as a ConnectX-7 adapter. A second CPU 920 can be connected to the first CPU 908 as well as a network interface card (NIC) 918. The second CPU 920 can also be connected, through another PCIe switch 914, to a network adapter 912 and one or more memory controllers 916.

An example Nvidia DGX (Deep GPU Xceleration) implementation can include a number of servers and workstations that are geared towards enhancing deep learning applications through the use of general-purpose computing on graphics processing units (GPUs). Such systems may come in a rackmount format featuring high-performance x86 server CPUs on the motherboard. A core feature of an example DGX system is its inclusion of 8 or more NVIDIA GPU modules, which are housed on an independent system board. These GPUs can be connected either via a version of the SXM socket or a PCIe x16 slot, facilitating flexible integration within the system architecture. To manage the substantial thermal output, DGX units are equipped with heatsinks and fans designed to maintain optimal operating temperatures. This framework makes DGX units suitable for computational tasks associated with artificial intelligence and machine learning models. In one embodiment, the GPUs can be connected using an NVLink mesh network.

Embodiments presented herein can provide for automated detection of issues in a datacenter through a capture and analysis of image data using at least one language model or AI actor.

### Virtualized Computing Platform

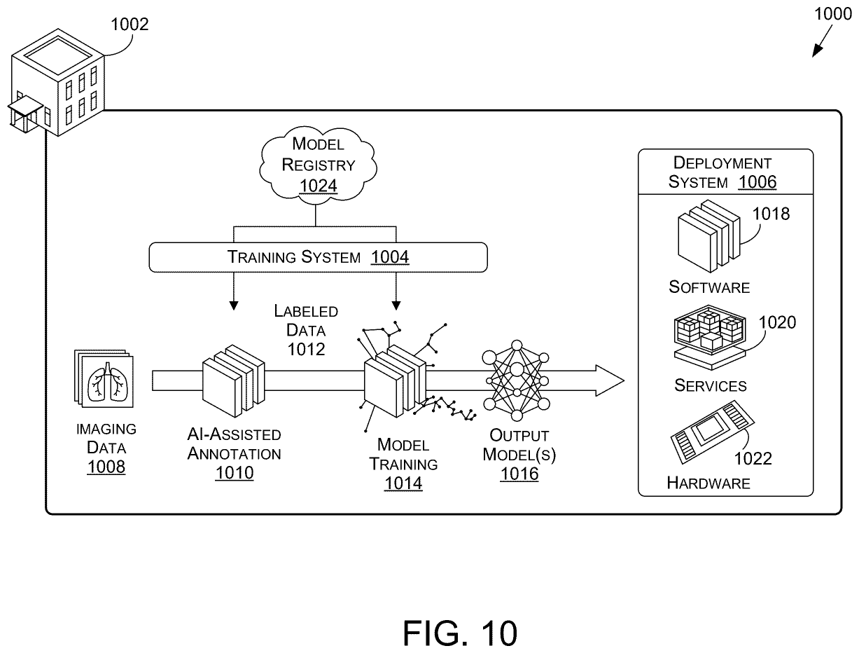

FIG. 10 is an example data flow diagram for a process 1000 of generating and deploying an image processing and inferencing pipeline, in accordance with at least one embodiment. In at least one embodiment, process 1000 may be deployed for use with imaging devices, processing devices, and/or other device types at one or more facilities 1002. Process 1000 may be executed within a training system 1004 and/or a deployment system 1006. In at least one embodiment, training system 1004 may be used to perform training, deployment, and implementation of machine learning models (e.g., neural networks, object detection algorithms, computer vision algorithms, etc.) for use in deployment system 1006. In at least one embodiment, deployment system 1006 may be configured to offload processing and compute resources among a distributed computing environment to reduce infrastructure requirements at facility 1002. In at least one embodiment, one or more applications in a pipeline may use or call upon services (e.g., inference, visualization, compute, AI, etc.) of deployment system 1006 during execution of applications.

In at least one embodiment, some of applications used in advanced processing and inferencing pipelines may use machine learning models or other AI to perform one or more processing steps. In at least one embodiment, machine learning models may be trained at facility 1002 using data 1008 (such as imaging data) generated at facility 1002 (and stored on one or more picture archiving and communication system (PACS) servers at facility 1002), may be trained using imaging or sequencing data 1008 from another facility(ies), or a combination thereof. In at least one embodiment, training system 1004 may be used to provide applications, services, and/or other resources for generating working, deployable machine learning models for deployment system 1006.

In at least one embodiment, model registry 1024 may be backed by object storage that may support versioning and object metadata. In at least one embodiment, object storage may be accessible through, for example, a cloud storage compatible application programming interface (API) from within a cloud platform. In at least one embodiment, machine learning models within model registry 1024 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training system 1004 may include a scenario where facility 1002 is training their own machine learning model, or has an existing machine learning model that needs to be optimized or updated. In at least one embodiment, imaging data 1008 generated by imaging device(s), sequencing devices, and/or other device types may be received. In at least one embodiment, once imaging data 1008 is received, AI-assisted annotation 1010 may be used to aid in generating annotations corresponding to imaging data 1008 to be used as ground truth data for a machine learning model. In at least one embodiment, AI-assisted annotation 1010 may include one or more machine learning models (e.g., convolutional neural networks (CNNs)) that may be trained to generate annotations corresponding to certain types of imaging data 1008 (e.g., from certain devices). In at least one embodiment, AI-assisted annotation 1010 may then be used directly, or may be adjusted or fine-tuned using an annotation tool to generate ground truth data. In at least one embodiment, AI-assisted annotation 1010, labeled data 1012, or a combination thereof may be used as ground truth data for training a machine learning model. In at least one embodiment, a trained machine learning model may be referred to as output model(s) 1016, and may be used by deployment system 1006, as described herein.

In at least one embodiment, a training pipeline may include a scenario where facility 1002 needs a machine learning model for use in performing one or more processing tasks for one or more applications in deployment system 1006, but facility 1002 may not currently have such a machine learning model (or may not have a model that is optimized, efficient, or effective for such purposes). In at least one embodiment, an existing machine learning model may be selected from a model registry 1024. In at least one embodiment, model registry 1024 may include machine learning models trained to perform a variety of different inference tasks on imaging data. In at least one embodiment, machine learning models in model registry 1024 may have been trained on imaging data from different facilities than facility 1002 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1024. In at least one embodiment, a machine learning model may then be retrained, or updated, at any number of other facilities, and a retrained or updated model may be made available in model registry 1024. In at least one embodiment, a machine learning model may then be selected from model registry 1024—and referred to as output model(s) 1016—and may be used in deployment system 1006 to perform one or more processing tasks for one or more applications of a deployment system.

In at least one embodiment, a scenario may include facility 1002 requiring a machine learning model for use in performing one or more processing tasks for one or more applications in deployment system 1006, but facility 1002 may not currently have such a machine learning model (or may not have a model that is optimized, efficient, or effective for such purposes). In at least one embodiment, a machine learning model selected from model registry 1024 may not be fine-tuned or optimized for imaging data 1008 generated at facility 1002 because of differences in populations, robustness of training data used to train a machine learning model, diversity in anomalies of training data, and/or other issues with training data. In at least one embodiment, AI-assisted annotation 1010 may be used to aid in generating annotations corresponding to imaging data 1008 to be used as ground truth data for retraining or updating a machine learning model. In at least one embodiment, labeled data 1012 may be used as ground truth data for training a machine learning model. In at least one embodiment, retraining or updating a machine learning model may be referred to as model training 1014. In at least one embodiment, model training 1014—e.g., AI-assisted annotation 1010, labeled data 1012, or a combination thereof—may be used as ground truth data for retraining or updating a machine learning model. In at least one embodiment, a trained machine learning model may be referred to as output model(s) 1016, and may be used by deployment system 1006, as described herein.

In at least one embodiment, deployment system 1006 may include software 1018, services 1020, hardware 1022, and/or other components, features, and functionality. In at least one embodiment, deployment system 1006 may include a software “stack,” such that software 1018 may be built on top of services 1020 and may use services 1020 to perform some or all of processing tasks, and services 1020 and software 1018 may be built on top of hardware 1022 and use hardware 1022 to execute processing, storage, and/or other compute tasks of deployment system 1006. In at least one embodiment, software 1018 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1008, in addition to containers that receive and configure imaging data for use by each container and/or for use by facility 1002 after processing through a pipeline (e.g., to convert outputs back to a usable data type). In at least one embodiment, a combination of containers within software 1018 (e.g., that make up a pipeline) may be referred to as a virtual instrument (as described in more detail herein), and a virtual instrument may leverage services 1020 and hardware 1022 to execute some or all processing tasks of applications instantiated in containers.

In at least one embodiment, a data processing pipeline may receive input data (e.g., imaging data 1008) in a specific format in response to an inference request (e.g., a request from a user of deployment system 1006). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1016 of training system 1004.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1024 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1020 as a system. In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by process 1000 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system. In at least one embodiment, completed and validated applications or containers may be stored in a container registry and associated machine learning models may be stored in model registry 1024. In at least one embodiment, a requesting entity—who provides an inference or image processing request—may browse a container registry and/or model registry 1024 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1006 (e.g., a cloud) to perform processing of data processing pipeline. In at least one embodiment, processing by deployment system 1006 may include referencing selected elements (e.g., applications, containers, models, etc.) from a container registry and/or model registry 1024. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1020 may be leveraged. In at least one embodiment, services 1020 may include compute services, artificial intelligence (AI) services, visualization services, and/or other service types. In at least one embodiment, services 1020 may provide functionality that is common to one or more applications in software 1018, so functionality may be abstracted to a service that may be called upon or leveraged by applications. In at least one embodiment, functionality provided by services 1020 may run dynamically and more efficiently, while also scaling well by allowing applications to process data in parallel (e.g., using a parallel computing platform). In at least one embodiment, rather than each application that shares a same functionality offered by services 1020 being required to have a respective instance of services 1020, services 1020 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where services 1020 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1018 implementing advanced processing and inferencing pipeline that includes segmentation application and anomaly detection application may be streamlined because each application may call upon a same inference service to perform one or more inferencing tasks.

In at least one embodiment, hardware 1022 may include GPUs, CPUs, graphics cards, an AI/deep learning system (e.g., an AI supercomputer, such as NVIDIA's DGX), a cloud platform, or a combination thereof. In at least one embodiment, different types of hardware 1022 may be used to provide efficient, purpose-built support for software 1018 and services 1020 in deployment system 1006. In at least one embodiment, use of GPU processing may be implemented for processing locally (e.g., at facility 1002), within an AI/deep learning system, in a cloud system, and/or in other processing components of deployment system 1006 to improve efficiency, accuracy, and efficacy of image processing and generation. In at least one embodiment, software 1018 and/or services 1020 may be optimized for GPU processing with respect to deep learning, machine learning, and/or high-performance computing, as non-limiting examples. In at least one embodiment, at least some of computing environment of deployment system 1006 and/or training system 1004 may be executed in a datacenter one or more supercomputers or high performance computing systems, with GPU optimized software (e.g., hardware and software combination of NVIDIA's DGX System). In at least one embodiment, hardware 1022 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

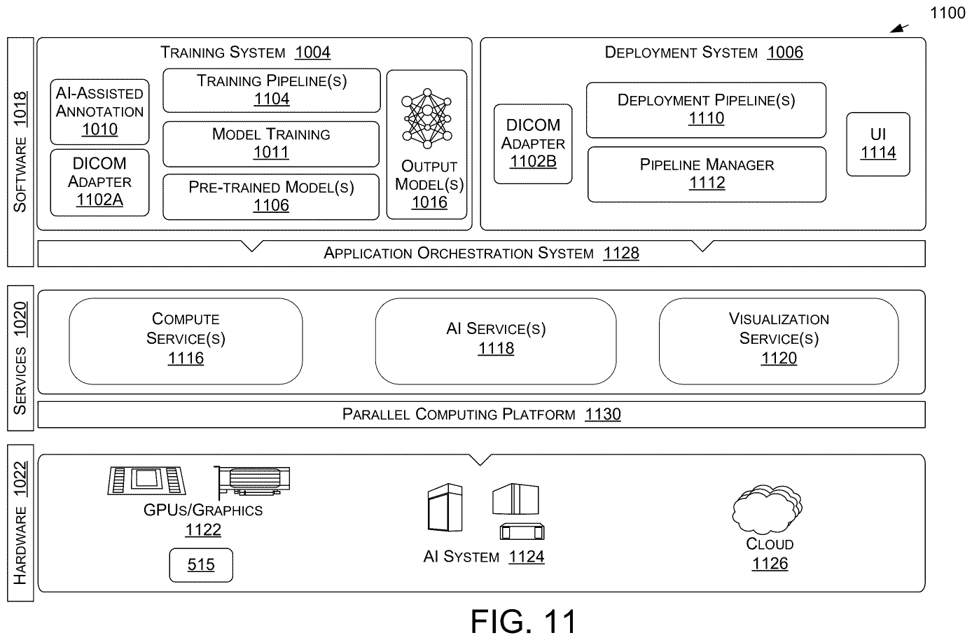

FIG. 11 is a system diagram for an example system 1100 for generating and deploying an imaging deployment pipeline, in accordance with at least one embodiment. In at least one embodiment, system 1100 may be used to implement processes including advanced processing and inferencing pipelines. In at least one embodiment, system 1100 may include training system 1004 and deployment system 1006. In at least one embodiment, training system 1004 and deployment system 1006 may be implemented using software 1018, services 1020, and/or hardware 1022, as described herein.

In at least one embodiment, system 1100 (e.g., training system 1004 and/or deployment system 1006) may implemented in a cloud computing environment (e.g., using cloud 1126). In at least one embodiment, system 1100 may be implemented locally with respect to a healthcare services facility, or as a combination of both cloud and local computing resources. In at least one embodiment, access to APIs in cloud 1126 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1100, may be restricted to a set of public IPs that have been vetted or authorized for interaction.

In at least one embodiment, various components of system 1100 may communicate between and among one another using any of a variety of different network types, including but not limited to local area networks (LANs) and/or wide area networks (WANs) via wired and/or wireless communication protocols. In at least one embodiment, communication between facilities and components of system 1100 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1004 may execute training pipelines 1404, similar to those described herein with respect to FIG. 10. In at least one embodiment, where one or more machine learning models are to be used in deployment pipeline(s) 1110 by deployment system 1006, training pipelines 1104 may be used to train or retrain one or more (e.g. pre-trained) models, and/or implement one or more of pre-trained models 1106 (e.g., without a need for retraining or updating). In at least one embodiment, as a result of training pipelines 1104, output model(s) 1016 may be generated. In at least one embodiment, training pipelines 1104 may include any number of processing steps, such as but not limited to imaging data (or other input data) conversion or adaption In at least one embodiment, for different machine learning models used by deployment system 1006, different training pipelines 1104 may be used. In at least one embodiment, training pipeline 1104 similar to a first example described with respect to FIG. 10 may be used for a first machine learning model, training pipeline 1104 similar to a second example described with respect to FIG. 10 may be used for a second machine learning model, and training pipeline 1104 similar to a third example described with respect to FIG. 10 may be used for a third machine learning model. In at least one embodiment, any combination of tasks within training system 1004 may be used depending on what is required for each respective machine learning model. In at least one embodiment, one or more of machine learning models may already be trained and ready for deployment so machine learning models may not undergo any processing by training system 1004, and may be implemented by deployment system 1006.

In at least one embodiment, output model(s) 1016 and/or pre-trained models 1406 may include any types of machine learning models depending on implementation or embodiment. In at least one embodiment, and without limitation, machine learning models used by system 1100 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipelines 1104 may include AI-assisted annotation, as described in more detail herein with respect to at least FIG. 11. In at least one embodiment, labeled data 1012 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1008 (or other data type used by machine learning models), there may be corresponding ground truth data generated by training system 1004. In at least one embodiment, AI-assisted annotation may be performed as part of deployment pipeline(s) 1110; either in addition to, or in lieu of AI-assisted annotation included in training pipelines 1104. In at least one embodiment, system 1100 may include a multi-layer platform that may include a software layer (e.g., software 1018) of diagnostic applications (or other application types) that may perform one or more medical imaging and diagnostic functions. In at least one embodiment, system 1100 may be communicatively coupled to (e.g., via encrypted links) PACS server networks of one or more facilities. In at least one embodiment, system 1100 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1002). In at least one embodiment, applications may then call or execute one or more services 1020 for performing compute, AI, or visualization tasks associated with respective applications, and software 1018 and/or services 1020 may leverage hardware 1022 to perform processing tasks in an effective and efficient manner. In at least one embodiment, communications sent to, or received by, a training system 1004 and a deployment system 1006 may occur using a pair of DICOM adapters 1102A, 1102B.

In at least one embodiment, deployment system 1006 may execute deployment pipeline(s) 1110. In at least one embodiment, deployment pipeline(s) 1110 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline(s) 1110 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1110 depending on information desired from data generated by a device. In at least one embodiment, where detections of anomalies are desired from an MRI machine, there may be a first deployment pipeline(s) 1110, and where image enhancement is desired from output of an MRI machine, there may be a second deployment pipeline(s) 1110.

In at least one embodiment, an image generation application may include a processing task that includes use of a machine learning model. In at least one embodiment, a user may desire to use their own machine learning model, or to select a machine learning model from model registry 1024. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1100—such as services 1020 and hardware 1022—deployment pipeline(s) 1410 may be even more user friendly, provide for easier integration, and produce more accurate, efficient, and timely results.

In at least one embodiment, deployment system 1006 may include a user interface (“UI”) 1114 (e.g., a graphical user interface, a web interface, etc.) that may be used to select applications for inclusion in deployment pipeline(s) 1110, arrange applications, modify or change applications or parameters or constructs thereof, use and interact with deployment pipeline(s) 1110 during set-up and/or deployment, and/or to otherwise interact with deployment system 1006. In at least one embodiment, although not illustrated with respect to training system 1004, UI 1114 (or a different user interface) may be used for selecting models for use in deployment system 1006, for selecting models for training, or retraining, in training system 1004, and/or for otherwise interacting with training system 1004.

In at least one embodiment, pipeline manager 1112 may be used, in addition to an application orchestration system 1128, to manage interaction between applications or containers of deployment pipeline(s) 1110 and services 1020 and/or hardware 1022. In at least one embodiment, pipeline manager 1112 may be configured to facilitate interactions from application to application, from application to services 1020, and/or from application or service to hardware 1022. In at least one embodiment, although illustrated as included in software 1018, this is not intended to be limiting, and in some examples pipeline manager 1112 may be included in services 1020. In at least one embodiment, application orchestration system 1128 (e.g., Kubernetes, DOCKER, etc.) may include a container orchestration system that may group applications into containers as logical units for coordination, management, scaling, and deployment. In at least one embodiment, by associating applications from deployment pipeline(s) 1110 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1112 and application orchestration system 1128. In at least one embodiment, so long as an expected input and/or output of each container or application is known by a system (e.g., based on constructs of applications or containers), application orchestration system 1128 and/or pipeline manager 1112 may facilitate communication among and between, and sharing of resources among and between, each of applications or containers. In at least one embodiment, because one or more of applications or containers in deployment pipeline(s) 1110 may share same services and resources, application orchestration system 1128 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1128) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1020 leveraged by and shared by applications or containers in deployment system 1006 may include compute service(s) 1116, AI service(s) 1118, visualization service(s) 1120, and/or other service types. In at least one embodiment, applications may call (e.g., execute) one or more of services 1020 to perform processing operations for an application. In at least one embodiment, compute service(s) 1116 may be leveraged by applications to perform super-computing or other high-performance computing (HPC) tasks. In at least one embodiment, compute service(s) 1116 may be leveraged to perform parallel processing (e.g., using a parallel computing platform 1130) for processing data through one or more of applications and/or one or more tasks of a single application, substantially simultaneously. In at least one embodiment, parallel computing platform 1130 (e.g., NVIDIA's CUDA) may enable general purpose computing on GPUs (GPGPU) (e.g., GPUs/Graphics 1122). In at least one embodiment, a software layer of parallel computing platform 1130 may provide access to virtual instruction sets and parallel computational elements of GPUs, for execution of compute kernels. In at least one embodiment, parallel computing platform 1130 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1130 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1118 may be leveraged to perform inferencing services for executing machine learning model(s) associated with applications (e.g., tasked with performing one or more processing tasks of an application). In at least one embodiment, AI service(s) 1118 may leverage AI system 1124 to execute machine learning model(s) (e.g., neural networks, such as CNNs) for segmentation, reconstruction, object detection, feature detection, classification, and/or other inferencing tasks. In at least one embodiment, applications of deployment pipeline(s) 1110 may use one or more of output model(s) 1016 from training system 1004 and/or other models of applications to perform inference on imaging data. In at least one embodiment, two or more examples of inferencing using application orchestration system 1128 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1128 may distribute resources (e.g., services 1020 and/or hardware 1022) based on priority paths for different inferencing tasks of AI service(s) 1118.

In at least one embodiment, shared storage may be mounted to AI service(s) 1118 within system 1100. In at least one embodiment, shared storage may operate as a cache (or other storage device type) and may be used to process inference requests from applications. In at least one embodiment, when an inference request is submitted, a request may be received by a set of API instances of deployment system 1006, and one or more instances may be selected (e.g., for best fit, for load balancing, etc.) to process a request. In at least one embodiment, to process a request, a request may be entered into a database, a machine learning model may be located from model registry 1024 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1112) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1020 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1126, and an inference service may perform inferencing on a GPU.

In at least one embodiment, visualization service(s) 1120 may be leveraged to generate visualizations for viewing outputs of applications and/or deployment pipeline(s) 1110. In at least one embodiment, GPUs/Graphics 1122 may be leveraged by visualization service(s) 1120 to generate visualizations. In at least one embodiment, rendering effects, such as ray-tracing, may be implemented by visualization service(s) 1120 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1120 may include an internal visualizer, cinematics, and/or other rendering or image processing capabilities or functionality (e.g., ray tracing, rasterization, internal optics, etc.).

In at least one embodiment, hardware 1022 may include GPUs/Graphics 1122, AI system 1124, cloud 1126, and/or any other hardware used for executing training system 1004 and/or deployment system 1006. In at least one embodiment, GPUs/Graphics 1122 (e.g., NVIDIA's TESLA and/or QUADRO GPUs) may include any number of GPUs that may be used for executing processing tasks of compute service(s) 1116, AI service(s) 1118, visualization service(s) 1120, other services, and/or any of features or functionality of software 1018. For example, with respect to AI service(s) 1118, GPUs/Graphics 1122 may be used to perform pre-processing on imaging data (or other data types used by machine learning models), post-processing on outputs of machine learning models, and/or to perform inferencing (e.g., to execute machine learning models). In at least one embodiment, cloud 1126, AI system 1124, and/or other components of system 1100 may use GPUs/Graphics 1122. In at least one embodiment, cloud 1126 may include a GPU-optimized platform for deep learning tasks. In at least one embodiment, AI system 1124 may use GPUs, and cloud 1126—or at least a portion tasked with deep learning or inferencing—may be executed using one or more AI systems 1124. As such, although hardware 1022 is illustrated as discrete components, this is not intended to be limiting, and any components of hardware 1022 may be combined with, or leveraged by, any other components of hardware 1022.

In at least one embodiment, AI system 1124 may include a purpose-built computing system (e.g., a super-computer or an HPC) configured for inferencing, deep learning, machine learning, and/or other artificial intelligence tasks. In at least one embodiment, AI system 1124 (e.g., NVIDIA's DGX) may include GPU-optimized software (e.g., a software stack) that may be executed using a plurality of GPUs/Graphics 1122, in addition to CPUs, RAM, storage, and/or other components, features, or functionality. In at least one embodiment, one or more AI systems 1124 may be implemented in cloud 1126 (e.g., in a datacenter) for performing some or all of AI-based processing tasks of system 1100.

In at least one embodiment, cloud 1126 may include a GPU-accelerated infrastructure (e.g., NVIDIA's NGC) that may provide a GPU-optimized platform for executing processing tasks of system 1100. In at least one embodiment, cloud 1126 may include an AI system 1124 for performing one or more of AI-based tasks of system 1100 (e.g., as a hardware abstraction and scaling platform). In at least one embodiment, cloud 1126 may integrate with application orchestration system 1128 leveraging multiple GPUs to enable seamless scaling and load balancing between and among applications and services 1020. In at least one embodiment, cloud 1126 may tasked with executing at least some of services 1020 of system 1100, including compute service(s) 1116, AI service(s) 1118, and/or visualization service(s) 1120, as described herein. In at least one embodiment, cloud 1126 may perform small and large batch inference (e.g., executing NVIDIA's TENSOR RT), provide an accelerated parallel computing API and platform 1130 (e.g., NVIDIA's CUDA), execute application orchestration system 1128 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1100.

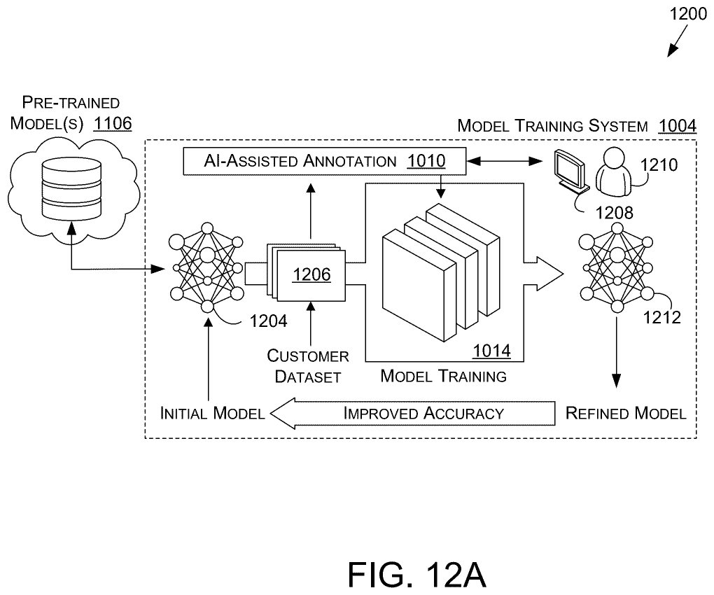

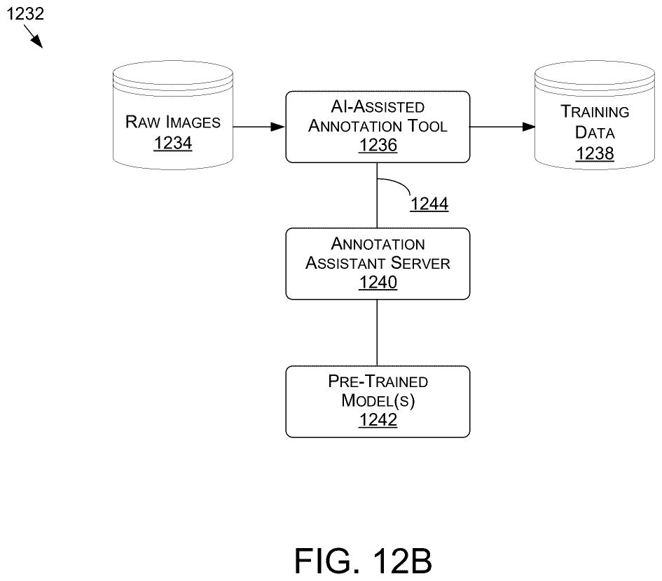

FIG. 12A illustrates a data flow diagram for a process 1200 to train, retrain, or update a machine learning model, in accordance with at least one embodiment. In at least one embodiment, process 1200 may be executed using, as a non-limiting example, system 1100 of FIG. 11. In at least one embodiment, process 1200 may leverage services and/or hardware as described herein. In at least one embodiment, refined models 1212 generated by process 1200 may be executed by a deployment system for one or more containerized applications in deployment pipelines.

In at least one embodiment, model training 1214 may include retraining or updating an initial model 1204 (e.g., a pre-trained model) using new training data (e.g., new input data, such as customer dataset 1206, and/or new ground truth data associated with input data). In at least one embodiment, to retrain, or update, initial model 1204, output or loss layer(s) of initial model 1204 may be reset, deleted, and/or replaced with an updated or new output or loss layer(s). In at least one embodiment, initial model 1204 may have previously fine-tuned parameters (e.g., weights and/or biases) that remain from prior training, so training or retraining 1214 may not take as long or require as much processing as training a model from scratch. In at least one embodiment, during model training 1214, by having reset or replaced output or loss layer(s) of initial model 1204, parameters may be updated and re-tuned for a new data set based on loss calculations associated with accuracy of output or loss layer(s) at generating predictions on new, customer dataset 1206.

In at least one embodiment, pre-trained models 1206 may be stored in a data store, or registry. In at least one embodiment, pre-trained models 1206 may have been trained, at least in part, at one or more facilities other than a facility executing process 1200. In at least one embodiment, to protect privacy and rights of patients, subjects, or clients of different facilities, pre-trained models 1206 may have been trained, on-premise, using customer or patient data generated on-premise. In at least one embodiment, pre-trained models 1106 may be trained using a cloud and/or other hardware, but confidential, privacy protected patient data may not be transferred to, used by, or accessible to any components of a cloud (or other off premise hardware). In at least one embodiment, where pre-trained models 1206 is trained at using patient data from more than one facility, pre-trained models 1206 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained models 1206 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select a pre-trained model to use with an application. In at least one embodiment, pre-trained model may not be optimized for generating accurate results on customer dataset 1206 of a facility of a user (e.g., based on patient diversity, demographics, types of medical imaging devices used, etc.). In at least one embodiment, prior to deploying a pre-trained model into a deployment pipeline for use with an application(s), pre-trained model may be updated, retrained, and/or fine-tuned for use at a respective facility.

In at least one embodiment, a user may select pre-trained model that is to be updated, retrained, and/or fine-tuned, and this pre-trained model may be referred to as initial model 1204 for a training system within process 1200. In at least one embodiment, a customer dataset 1206 (e.g., imaging data, genomics data, sequencing data, or other data types generated by devices at a facility) may be used to perform model training (which may include, without limitation, transfer learning) on initial model 1204 to generate refined model 1212. In at least one embodiment, ground truth data corresponding to customer dataset 1206 may be generated by training system 1304. In at least one embodiment, ground truth data may be generated, at least in part, by clinicians, scientists, doctors, practitioners, at a facility.

In at least one embodiment, AI-assisted annotation may be used in some examples to generate ground truth data. In at least one embodiment, AI-assisted annotation (e.g., implemented using an AI-assisted annotation SDK) may leverage machine learning models (e.g., neural networks) to generate suggested or predicted ground truth data for a customer dataset. In at least one embodiment, a user may use annotation tools within a user interface (a graphical user interface (GUI)) on a computing device.

In at least one embodiment, user 1210 may interact with a GUI via computing device 1208 to edit or fine-tune (auto)annotations. In at least one embodiment, a polygon editing feature may be used to move vertices of a polygon to more accurate or fine-tuned locations.

In at least one embodiment, once customer dataset 1206 has associated ground truth data, ground truth data (e.g., from AI-assisted annotation, manual labeling, etc.) may be used by during model training to generate refined model 1212. In at least one embodiment, customer dataset 1206 may be applied to initial model 1204 any number of times, and ground truth data may be used to update parameters of initial model 1204 until an acceptable level of accuracy is attained for refined model 1212. In at least one embodiment, once refined model 1212 is generated, refined model 1212 may be deployed within one or more deployment pipelines at a facility for performing one or more processing tasks with respect to medical imaging data.

In at least one embodiment, refined model 1212 may be uploaded to pre-trained models in a model registry to be selected by another facility. In at least one embodiment, this process may be completed at any number of facilities such that refined model 1212 may be further refined on new datasets any number of times to generate a more universal model.

FIG. 12B is an example illustration of a client-server architecture 1232 to enhance annotation tools with pre-trained annotation models, in accordance with at least one embodiment. In at least one embodiment, AI-assisted annotation tool 1236 may be instantiated based on a client-server architecture 1232. In at least one embodiment, AI-assisted annotation tool 1236 in imaging applications may aid radiologists, for example, identify organs and abnormalities. In at least one embodiment, imaging applications may include software tools that help user 1210 to identify, as a non-limiting example, a few extreme points on a particular organ of interest in raw images 1234 (e.g., in a 3D MRI or CT scan) and receive auto-annotated results for all 2D slices of a particular organ. In at least one embodiment, results may be stored in a data store as training data 1238 and used as (for example and without limitation) ground truth data for training. In at least one embodiment, when computing device 1208 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1236 in FIG. 12B, may be enhanced by making API calls (e.g., API Call 1244) to a server, such as an Annotation Assistant Server 1240 that may include a set of pre-trained models 1242 stored in an annotation model registry, for example. In at least one embodiment, an annotation model registry may store pre-trained models 1242 (e.g., machine learning models, such as deep learning models) that are pre-trained to perform AI-assisted annotation on a particular organ or abnormality. These models may be further updated by using training pipelines. In at least one embodiment, pre-installed annotation tools may be improved over time as new labeled data is added.

Various embodiments can be described by the following clauses:
1. A system, comprising:
one or more processing units to:
receive image data captured to include a representation of one or more components in a datacenter;
analyze the image data using a first machine learning model to determine a physical state for the one or more components;
provide a textual description of the physical state, generated using the first machine learning model, as input to a second machine learning model having access to operational data for the one or more components; and
generate, using the second machine learning model, a report corresponding to at least the one or more components in the datacenter, the report identifying one or more issues identified with respect to the one or more components.
2. The system of clause 1, wherein the one or more processing units are further to provide one or more remedial actions recommended to be performed for the one or more issues based in part on the textual description of the physical state for the one or more components.
3. The system of clause 1, wherein the image data includes at least one sequence of images or segment of video data captured during operation of the one or more components over a period of time.
4. The system of clause 1, wherein the second machine learning model is a large language model, and wherein the one or more processing units are further to:
provide a query as additional input to the second machine learning model, the query relating to the one or more components in the datacenter.
5. The system of clause 1, wherein the query is received from a user, received from an management application, generated by the first machine learning model, or generated by the second machine learning model.
6. The system of clause 1, wherein the one or more issues relate to at least one of the physical state or an operational state of the one or more components.
7. The system of clause 1, wherein the one or more processing units are further to:
receive additional physical state data captured for the one or more components, the additional physical state data including at least one of audio, odor, temperature, motion, infrared, ultraviolet, or vibration data.
8. The system of clause 1, wherein the textual description of the physical state includes identifying information captured for the one or more components.
9. The system of clause 1, wherein the one or more processing units are further to:
cause at least one of the one or more remedial actions to be automatically performed with respect to the one or more components.
10. The system of clause 1, wherein the image data is caused to be captured in response to a potential issue identified with respect to one or more components in the datacenter.
11. A resource monitoring device, comprising:
at least one camera to capture image data for one or more resources in a shared resource environment including a plurality of resources of a plurality of resource types;
at least one processor to:
analyze the captured image data, using a first machine learning model, to generate a textual description of a physical state of the one or more resources;
provide, in response to identifying a potential issue with the one or more resources, the textual description as input to a second machine learning model having access to operational data for the one or more resources and able to identify one or more issues identified with respect to the one or more resources based in part on the operational data and the textual description of the physical state; and
cause, in response to the identified one or more issues, at least one remedial action to be performed.
12. The resource monitoring device of clause 11, further comprising:
at least one moveable mechanism allowing a camera to be automatically positioned with respect to the one or more resources in order to capture the image data.
13. The resource monitoring device of clause 11, wherein the at least one remedial action is performed automatically by the resource monitoring device or by a human receiving instructions from the resource monitoring device.
14. The resource monitoring device of clause 11, further comprising at least one additional sensor to capture additional physical state data for the one or more resources, the additional physical state data including at least one of audio, odor, temperature, motion, infrared, ultraviolet, or vibration data.
15. The resource monitoring device of clause 11, wherein the resource monitoring device is to be used to monitor at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a datacenter;
a system for performing hardware testing using simulation;
a system for performing generative operations using a language model (LM);
a system for synthetic data generation;
a collaborative content creation platform for 3D assets; or
a system implemented at least partially using cloud computing resources.
16. A method, comprising:
causing sensor data to be captured representing a current view of one or more components in a shared resource environment;
generating, using a first language model, a textual description of a current physical state of the one or more components;
comparing, using a second language model, the textual description of the current physical state against one or more textual descriptions of typical physical conditions, observed for the one or more components during operation, to identify one or more anomalies; and
generating a notification corresponding to the one or more anomalies if the second language model infers that the one or more anomalies have at least a minimum probability of being associated with an operational issue impacting the shared resource environment.
17. The method of clause 16, further comprising:
recommending one or more remedial actions to be performed with respect to the operational issue based in part on the textual description of the current physical state of the one or more components.

18. The method of clause 16, further comprising:
receiving a query relating to performance of the one or more components in the shared resource environment; and
causing the sensor data to be captured, in response to the query, to be used to determine the current physical state of the one or more components.

19. The method of clause 18, wherein a robotic assembly is allowed to move to a location proximate the one or more components in order to use at least one sensor, of the robotic assembly, to capture the sensor data.

20. The method of clause 16, wherein the one or more components in a shared resource environment are comprised in:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a datacenter;
a system for performing hardware testing using simulation;
a system for performing generative operations using a language model (LM);
a system for synthetic data generation;
a collaborative content creation platform for 3D assets; or
a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system, comprising:
one or more processing units to:
receive image data captured to include a representation of one or more components in a datacenter;
analyze the image data using a first machine learning model to determine a physical state for the one or more components;
provide a textual description of the physical state, generated using the first machine learning model, as input to a second machine learning model having access to operational data for the one or more components; and
generate, using the second machine learning model, a report corresponding to at least the one or more components in the datacenter, the report identifying one or more issues identified with respect to the one or more components.

2. The system of claim 1, wherein the one or more processing units are further to provide one or more remedial actions recommended to be performed for the one or more issues based in part on the textual description of the physical state for the one or more components.

3. The system of claim 1, wherein the image data includes at least one sequence of images or segment of video data captured during operation of the one or more components over a period of time.

4. The system of claim 1, wherein the second machine learning model is a large language model, and wherein the one or more processing units are further to:
provide a query as additional input to the second machine learning model, the query relating to the one or more components in the datacenter.

5. The system of claim 1, wherein the query is received from a user, received from an management application, generated by the first machine learning model, or generated by the second machine learning model.

6. The system of claim 1, wherein the one or more issues relate to at least one of the physical state or an operational state of the one or more components.

7. The system of claim 1, wherein the one or more processing units are further to:
receive additional physical state data captured for the one or more components, the additional physical state data including at least one of audio, odor, temperature, motion, infrared, ultraviolet, or vibration data.

8. The system of claim 1, wherein the textual description of the physical state includes identifying information captured for the one or more components.

9. The system of claim 1, wherein the one or more processing units are further to:
cause at least one of the one or more remedial actions to be automatically performed with respect to the one or more components.

10. The system of claim 1, wherein the image data is caused to be captured in response to a potential issue identified with respect to one or more components in the datacenter.

11. A resource monitoring device, comprising:
at least one camera to capture image data for one or more resources in a shared resource environment including a plurality of resources of a plurality of resource types;
at least one processor to:
analyze the captured image data, using a first machine learning model, to generate a textual description of a physical state of the one or more resources;
provide, in response to identifying a potential issue with the one or more resources, the textual description as input to a second machine learning model having access to operational data for the one or more resources and able to identify one or more issues identified with respect to the one or more resources based in part on the operational data and the textual description of the physical state; and
cause, in response to the identified one or more issues, at least one remedial action to be performed.

12. The resource monitoring device of claim 11, further comprising:
at least one moveable mechanism allowing a camera to be automatically positioned with respect to the one or more resources in order to capture the image data.

13. The resource monitoring device of claim 11, wherein the at least one remedial action is performed automatically by the resource monitoring device or by a human receiving instructions from the resource monitoring device.

14. The resource monitoring device of claim 11, further comprising at least one additional sensor to capture additional physical state data for the one or more resources, the additional physical state data including at least one of audio, odor, temperature, motion, infrared, ultraviolet, or vibration data.

15. The resource monitoring device of claim 11, wherein the resource monitoring device is to be used to monitor at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a datacenter;
a system for performing hardware testing using simulation;
a system for performing generative operations using a language model (LM);
a system for synthetic data generation;
a collaborative content creation platform for 3D assets; or
a system implemented at least partially using cloud computing resources.

16. A method, comprising:
causing sensor data to be captured representing a current view of one or more components in a shared resource environment;
generating, using a first language model, a textual description of a current physical state of the one or more components;
comparing, using a second language model, the textual description of the current physical state against one or more textual descriptions of typical physical conditions, observed for the one or more components during operation, to identify one or more anomalies; and
generating a notification corresponding to the one or more anomalies if the second language model infers that the one or more anomalies have at least a minimum probability of being associated with an operational issue impacting the shared resource environment.

17. The method of claim 16, further comprising:
recommending one or more remedial actions to be performed with respect to the operational issue based in part on the textual description of the current physical state of the one or more components.

18. The method of claim 16, further comprising:
receiving a query relating to performance of the one or more components in the shared resource environment; and
causing the sensor data to be captured, in response to the query, to be used to determine the current physical state of the one or more components.

19. The method of claim 18, wherein a robotic assembly is allowed to move to a location proximate the one or more components in order to use at least one sensor, of the robotic assembly, to capture the sensor data.

20. The method of claim 16, wherein the one or more components in a shared resource environment are comprised in:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a datacenter;
a system for performing hardware testing using simulation;
a system for performing generative operations using a language model (LM);
a system for synthetic data generation;
a collaborative content creation platform for 3D assets; or
a system implemented at least partially using cloud computing resources.
